(19) United States
(12) Patent Application Publication
(10) Pub. No.: US 2024/0414649 A1
(43) Pub. Date: Dec. 12, 2024

(54) TECHNIQUES FOR INDICATING COMMUNICATION POWER STATES

(71) Applicant: QUALCOMM Incorporated, San Diego, CA (US)

(72) Inventors: Diana MAAMARI, San Diego, CA (US); Ahmed ELSHAFIE, San Diego, CA (US); Mickael MONDET, Louannec (FR); Prashanth Haridas HANDE, San Diego, CA (US); Huilin XU, Temecula, CA (US); Linhai HE, San Diego, CA (US); Konstantinos DIMOU, New York, NY (US); Ahmed Attia ABOTABL, San Diego, CA (US)

(21) Appl. No.: 18/331,823

(22) Filed: Jun. 8, 2023

(51) Int. Cl. H04W 52/02; H04W 52/14

(52) U.S. Cl. CPC H04W 52/0229; H04W 52/14

(57) ABSTRACT

Methods, systems, and devices for wireless communications are described. A network entity may configure a mapping between a set of power states and a set of codepoints. The network entity may indicate the mapping to a user equipment (UE) via control signaling, such as a first control message. Each power state may correspond to a respective directional communication profile associated with the network entity, the UE, or both. The network entity may transmit a second control message to the UE to indicate a codepoint from the set of codepoints. The UE device may transition to a power state that corresponds to the codepoint (e.g., based on the mapping) in accordance with the second control message. In some examples, the network entity may indicate the codepoint in a field of the second control message associated with a search space set group (SSSG) switching indication.

### TECHNICAL FIELD

The following relates to wireless communications, including techniques for indicating communication power states.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for indicating communication power states. For example, the described techniques provide for a mapping between power states and codepoints. A first wireless device (e.g., a user equipment (UE), a network entity) may configure and indicate the mapping to a second wireless device (e.g., a UE, a network entity) via control signaling, such as a first control message. The mapping may be between a set of power states and a set of codepoints, where the power states may correspond to directional communication profiles associated with the first wireless device, the second wireless device, or both. The first wireless device may transmit a second control message to the second wireless device to indicate a codepoint from the set of codepoints. The second wireless device may transition to a power state that corresponds to the codepoint (e.g., based on the mapping) based on receiving the second control message. In some examples, the second control message may indicate the codepoint in a field associated with a search space set group (SSSG) switching indication.

A method for wireless communications at a UE is described. The method may include receiving a first control message that indicates a mapping between individual ones of a set of power states and respective ones of a set of codepoints, each power state of the set of power states being for the UE or a network entity in communication with the UE and corresponding to a respective directional communication profile associated with the UE, receiving a second control message that includes a codepoint from the set of codepoints, the codepoint corresponding to a power state from the set of power states in accordance with the mapping, inclusion of the codepoint in the second control message indicative of activation of the power state at the UE, and transitioning to the power state in accordance with the second control message.

An apparatus for wireless communications at a UE is described. The apparatus may include at least one processor and memory coupled (e.g., operatively, communicatively, functionally, electronically, or electrically) with the at least one processor, the memory storing instructions executable by the at least one processor (e.g., directly, indirectly, after pre-processing, without pre-processing) to cause the apparatus to receive a first control message that indicates a mapping between individual ones of a set of power states and respective ones of a set of codepoints, each power state of the set of power states being for the UE or a network entity in communication with the UE and corresponding to a respective directional communication profile associated with the UE, receive a second control message that includes a codepoint from the set of codepoints, the codepoint corresponding to a power state from the set of power states in accordance with the mapping, inclusion of the codepoint in the second control message indicative of activation of the power state at the UE, and transition to the power state in accordance with the second control message.

Another apparatus for wireless communications at a UE is described. The apparatus may include means for receiving a first control message that indicates a mapping between individual ones of a set of power states and respective ones of a set of codepoints, each power state of the set of power states being for the UE or a network entity in communication with the UE and corresponding to a respective directional communication profile associated with the UE, means for receiving a second control message that includes a codepoint from the set of codepoints, the codepoint corresponding to a power state from the set of power states in accordance with the mapping, inclusion of the codepoint in the second control message indicative of activation of the power state at the UE, and means for transitioning to the power state in accordance with the second control message.

A non-transitory computer-readable medium storing code for wireless communications at a UE is described. The code may include instructions executable by at least one processor (e.g., directly, indirectly, after pre-processing, without pre-processing) to receive a first control message that indicates a mapping between individual ones of a set of power states and respective ones of a set of codepoints, each power state of the set of power states being for the UE or a network entity in communication with the UE and corresponding to a respective directional communication profile associated with the UE, receive a second control message that includes a codepoint from the set of codepoints, the codepoint corresponding to a power state from the set of power states in accordance with the mapping, inclusion of the codepoint in the second control message indicative of activation of the power state at the UE, and transition to the power state in accordance with the second control message.

In some examples of the method, apparatuses, and non-transitory computer-readable medium described herein, the second control message includes the codepoint within a field associated with an SSSG switching indication, where the method includes receiving an indication that the codepoint may be associated with the power state instead of with an SSSG switching indication.

In some examples of the method, apparatuses, and non-transitory computer-readable medium described herein, the method may include operations, features, means, or instructions for receiving an indication that changes an activation state of the mapping between the individual ones of the set of power states and the respective ones of the set of codepoints, where the activation state may be one of an activated state or a deactivated state.

In some examples of the method, apparatuses, and non-transitory computer-readable medium described herein, the respective directional communication profile may be associated with one or more of a bandwidth part (BWP) for a primary cell, one or more BWPs for one or more secondary cells, a dormant BWP for the primary cell, a dormant BWP for the one or more secondary cells, restricted reception of a data channel in the BWP for the primary cell, restricted reception of a control channel in the BWP for the primary cell, restricted reception of the data channel in the one or more BWPs for the one or more secondary cells, restricted reception of the control channel in the one or more BWPs for the one or more secondary cells, or a combination thereof.

In some examples of the method, apparatuses, and non-transitory computer-readable medium described herein, the set of power states includes a modem-off power state, one or more uplink-only power states corresponding to different uplink communication rates, one or more downlink-only power states corresponding to different downlink communication rates, an uplink-and-downlink power state, or combinations thereof.

In some examples of the method, apparatuses, and non-transitory computer-readable medium described herein, the power state includes a modem-off power state and the method, apparatuses, and non-transitory computer-readable medium may include further operations, features, means, or instructions for pausing, while operating in the power state, a monitoring of a downlink control channel and a downlink shared channel and pausing, while operating in the power state, transmission of an uplink control channel and an uplink shared channel.

In some examples of the method, apparatuses, and non-transitory computer-readable medium described herein, the power state includes an uplink-only power state and the method, apparatuses, and non-transitory computer-readable medium may include further operations, features, means, or instructions for pausing, while operating in the power state, a monitoring of a downlink shared channel, monitoring, while operating in the power state, a downlink control channel for an uplink configured grant indicating one or more sets of periodic uplink resources, and transmitting, while operating in the power state, an uplink message in accordance with the uplink configured grant.

In some examples of the method, apparatuses, and non-transitory computer-readable medium described herein, the power state includes a downlink-only power state and the method, apparatuses, and non-transitory computer-readable medium may include further operations, features, means, or instructions for pausing, while operating in the power state, transmission of at least one of an uplink control channel and an uplink shared channel, monitoring, while operating in the power state, a downlink control channel for a downlink configured grant indicating one or more downlink resources, and monitoring, while operating in the power state, a downlink shared channel for a downlink message in accordance with the downlink configured grant.

In some examples of the method, apparatuses, and non-transitory computer-readable medium described herein, the power state includes an uplink-and-downlink power state and the method, apparatuses, and non-transitory computer-readable medium may include further operations, features, means, or instructions for monitoring, while operating in the power state, a downlink control channel for at least one of a downlink configured grant and an uplink configured grant.

In some examples of the method, apparatuses, and non-transitory computer-readable medium described herein, the mapping includes an additional codepoint that may be mapped to a physical downlink control channel (PDCCH) skipping operation.

In some examples of the method, apparatuses, and non-transitory computer-readable medium described herein, the first control message indicates a set of timers corresponding to the set of power states and the method, apparatuses, and non-transitory computer-readable medium may include further operations, features, means, or instructions for transitioning from the power state to a second power state based on expiry of a timer associated with the power state. In some examples of the method, apparatuses, and non-transitory computer-readable medium described herein, the set of timers may be associated with SSSG switching.

A method for wireless communications at a network entity is described. The method may include transmitting, to a UE, a first control message that indicates a mapping between individual ones of a set of power states and respective ones of a set of codepoints, each power state of the set of power states being for the UE or the network entity and corresponding to a respective directional communication profile associated with the UE, transmitting, to the UE, a second control message that includes a codepoint from the set of codepoints, the codepoint corresponding to a power state from the set of power states in accordance with the mapping, inclusion of the codepoint in the second control message indicative of activation of the power state, and operating in accordance with the power state at the UE.

An apparatus for wireless communications at a network entity is described. The apparatus may include at least one processor and memory coupled with (e.g., operatively, communicatively, functionally, electronically, or electrically) the at least one processor, the memory storing instructions executable by the at least one processor (e.g., directly, indirectly, after pre-processing, without pre-processing) to cause the apparatus to transmit, to a UE, a first control message that indicates a mapping between individual ones of a set of power states and respective ones of a set of codepoints, each power state of the set of power states being for the UE or the network entity and corresponding to a respective directional communication profile associated with the UE, transmit, to the UE, a second control message that includes a codepoint from the set of codepoints, the codepoint corresponding to a power state from the set of power states in accordance with the mapping, inclusion of the codepoint in the second control message indicative of activation of the power state, and operate in accordance with the power state at the UE.

Another apparatus for wireless communications at a network entity is described. The apparatus may include means for transmitting, to a UE, a first control message that indicates a mapping between individual ones of a set of power states and respective ones of a set of codepoints, each power state of the set of power states being for the UE or the network entity and corresponding to a respective directional communication profile associated with the UE, means for transmitting, to the UE, a second control message that includes a codepoint from the set of codepoints, the codepoint corresponding to a power state from the set of power states in accordance with the mapping, inclusion of the codepoint in the second control message indicative of activation of the power state, and means for operating in accordance with the power state at the UE.

A non-transitory computer-readable medium storing code for wireless communications at a network entity is described. The code may include instructions executable by at least one processor (e.g., directly, indirectly, after pre-processing, without pre-processing) to transmit, to a UE, a first control message that indicates a mapping between individual ones of a set of power states and respective ones of a set of codepoints, each power state of the set of power states being for the UE or the network entity and corresponding to a respective directional communication profile associated with the UE, transmit, to the UE, a second control message that includes a codepoint from the set of codepoints, the codepoint corresponding to a power state from the set of power states in accordance with the mapping, inclusion of the codepoint in the second control message indicative of activation of the power state, and operate in accordance with the power state at the UE.

In some examples of the method, apparatuses, and non-transitory computer-readable medium described herein, the second control message includes the codepoint within a field associated with an SSSG switching indication, where the method includes transmitting an indication that the codepoint may be associated with the power state instead of with an SSSG switching indication.

Some examples of the method, apparatuses, and non-transitory computer-readable medium described herein may further include operations, features, means, or instructions for transmitting an indication that changes an activation state of the mapping between the individual ones of the set of power states and the respective ones of the set of codepoints, where the activation state may be one of an activated state or a deactivated state.

In some examples of the method, apparatuses, and non-transitory computer-readable medium described herein, the respective directional communication profile may be associated with a BWP for a primary cell, one or more BWPs for one or more secondary cells, a dormant BWP for the primary cell, a dormant BWP for the one or more secondary cells, restricted reception of a data channel in the BWP for the primary cell, restricted reception of a control channel in the BWP for the primary cell, restricted reception of the data channel in the one or more BWPs for the one or more secondary cells, restricted reception of the control channel in the one or more BWPs for the one or more secondary cells, or a combination thereof.

In some examples of the method, apparatuses, and non-transitory computer-readable medium described herein, the set of power states includes a modem-off power state, one or more uplink-only power states corresponding to different uplink communication rates, one or more downlink-only power states corresponding to different downlink communication rates, an uplink-and-downlink power state, or combinations thereof.

In some examples of the method, apparatuses, and non-transitory computer-readable medium described herein, the power state includes a modem-off power state and the method, apparatuses, and non-transitory computer-readable medium may include further operations, features, means, or instructions for pausing a monitoring of an uplink control channel and an uplink shared channel and pausing transmission of a downlink control channel and a downlink shared channel.

In some examples of the method, apparatuses, and non-transitory computer-readable medium described herein, the power state includes an uplink-only power state and the method, apparatuses, and non-transitory computer-readable medium may include further operations, features, means, or instructions for pausing transmission of a downlink shared channel, transmitting, via a downlink control channel, an uplink configured grant indicating one or more sets of periodic uplink resources, and receiving, from the UE via an uplink shared channel, an uplink message in accordance with the uplink configured grant.

In some examples of the method, apparatuses, and non-transitory computer-readable medium described herein, the power state includes a downlink-only power state and the method, apparatuses, and non-transitory computer-readable medium may include further operations, features, means, or instructions for pausing a monitoring of at least one of an uplink control channel and an uplink shared channel, transmitting, via a downlink control channel, a downlink configured grant indicating one or more downlink resources, and transmitting, via a downlink shared channel, a downlink message in accordance with the downlink configured grant.

In some examples of the method, apparatuses, and non-transitory computer-readable medium described herein, the power state includes an uplink-and-downlink power state and the method, apparatuses, and non-transitory computer-readable medium may include further operations, features, means, or instructions for transmitting, via a downlink control channel, at least one of a downlink configured grant and an uplink configured grant.

In some examples of the method, apparatuses, and non-transitory computer-readable medium described herein, the mapping includes an additional codepoint that may be mapped to a PDCCH skipping operation.

In some examples of the method, apparatuses, and non-transitory computer-readable medium described herein, the first control message indicates a set of timers corresponding to the set of power states.

### BRIEF DESCRIPTION OF THE DRAWINGS

FIGS. 1 and 2 show examples of wireless communications systems that supports techniques for indicating communication power states in accordance with one or more aspects of the present disclosure.

FIG. 3 shows an example of a process flow that supports techniques for indicating communication power states in accordance with one or more aspects of the present disclosure.

FIGS. 4 and 5 show block diagrams of devices that support techniques for indicating communication power states in accordance with one or more aspects of the present disclosure.

FIG. 6 shows a block diagram of a communications manager that supports techniques for indicating communication power states in accordance with one or more aspects of the present disclosure.

FIG. 7 shows a diagram of a system including a device that supports techniques for indicating communication power states in accordance with one or more aspects of the present disclosure.

FIGS. 8 and 9 show block diagrams of devices that support techniques for indicating communication power states in accordance with one or more aspects of the present disclosure.

FIG. 10 shows a block diagram of a communications manager that supports techniques for indicating communication power states in accordance with one or more aspects of the present disclosure.

FIG. 11 shows a diagram of a system including a device that supports techniques for indicating communication power states in accordance with one or more aspects of the present disclosure.

FIGS. 12 through 15 show flowcharts illustrating methods that support techniques for indicating communication power states in accordance with one or more aspects of the present disclosure.

### DETAILED DESCRIPTION

In some wireless communications systems, wireless devices, (e.g., user equipments (UEs), network entities) may support one or more power states. A wireless device may operate in a power state based on tradeoffs between communication performance and power savings. For example, some power states may be associated with operations, parameters, or behaviors that reduce power consumption at the wireless device. Other power states may be configured to support relatively high data throughput, e.g., at the cost of increased power consumption. A wireless device may switch between power states to adapt to various scenarios or to achieve appropriate performance. For instance, the wireless device may utilize different power states based on compensating for changes in channel conditions, meeting quality of service (QOS) requirements, or conserving power. In some cases, a power state may correspond to a directional communication profile associated with the wireless device.

Accordingly, techniques described herein support signaling to indicate power states and to indicate changes between power states. A first wireless device, such as a network entity, may configure a mapping between a set of power states and a set of codepoints, such that each power state of the set of power states corresponds to a respective codepoint of the set of codepoints. The power states may be associated with the network entity or another wireless device in communication with the network entity, such as a UE. The network entity may transmit, to the UE, a first control message (e.g., a radio resource control (RRC) message) that indicates the mapping. To activate a power state at the UE, the network entity may transmit a second control message (e.g., a media access control (MAC) control element (MAC-CE), downlink control information (DCI)) that includes a codepoint from the set of codepoints, the codepoint corresponding to the power state to be activated. Based on receiving the second control message, the UE may transition to the power state.

In some examples, to indicate the codepoint, the network entity may repurpose a field within the second control message. For example, the network entity may include the codepoint within a field that is associated with a search space set (SSS) group (SSSG) switching indication. Additionally, the network entity may activate or deactivate the mapping between the codepoints and the power states. When the mapping is activated, a codepoint included in the SSSG switching indication field may be used to indicate a power state. When the mapping is deactivated, a codepoint included in the SSSG switching indication field may be used to indicate SSSG switching.

Aspects of the disclosure are initially described in the context of wireless communications systems. Aspects of the disclosure are then discussed with reference to a process flow. Aspects of the disclosure are further illustrated by and described with reference to apparatus diagrams, system diagrams, and flowcharts that relate to techniques for indicating communication power states.

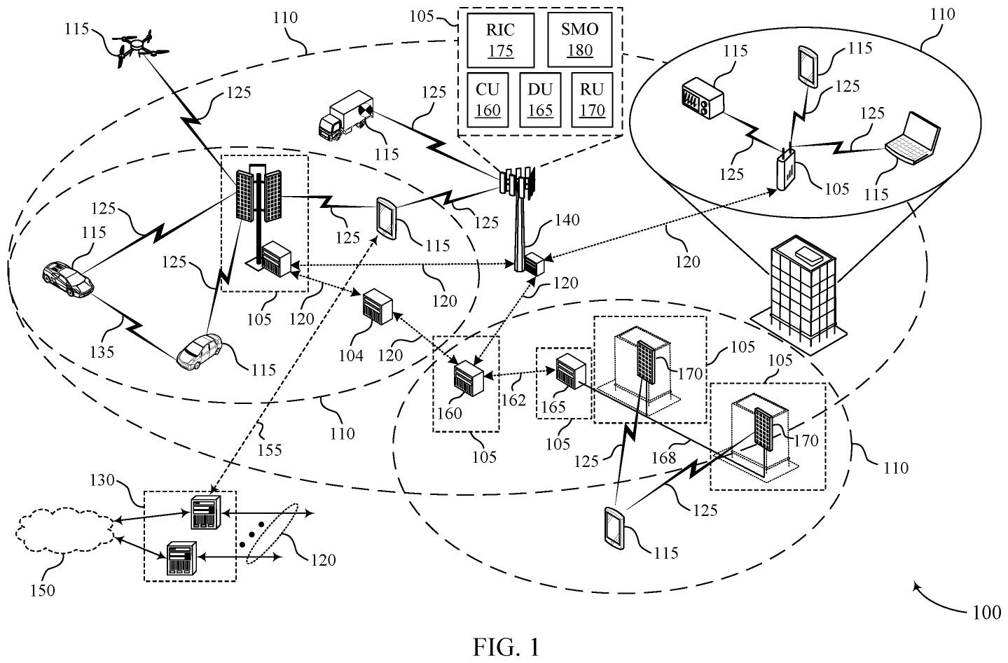

FIG. 1 shows an example of a wireless communications system 100 that supports techniques for indicating communication power states in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support TTI structure for ambient wireless device communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a TTI (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support multiple power states (e.g., network power states, network energy states, UE power states) for wireless devices, such as UEs 115 and network entities 105. Each power state may be associated with a configuration of a wireless device tailored for a respective traffic profile. That is, a power state may include or be an example of a set of parameters or behaviors that optimize operation of the wireless device in a corresponding communication state. For instance, some power states may be configured for high data rate or high throughput communications, while other power states may be configured for low data rate communications or low power consumption. In some cases, a power state may be configured to achieve maximum power savings while meeting quality of service (QOS) requirements for a corresponding traffic profile.

A wireless device may transition between power states to adapt to different communication scenarios or traffic profiles based on one or more timers, changes in traffic profiles, feedback information, or receiving an indication. A UE 115, for example, may transition from a first power state to a second power state based on receiving control signaling (e.g., DCI, MAC-CE) from a network entity 105, where the control signaling indicates the power state to the UE 115. The UE 115 may transition from the second power state back to the first power state based on expiry of a timer at the UE 115. In another example, the UE 115 may be configured to periodically transition between a first power state associated with relatively low power consumption and a second power state associated with relatively high data throughput, e.g., according to a duty cycle.

In some examples, a power state may include or be an example of a monitoring adaptation mechanism, such as physical downlink control channel (PDCCH) skipping or SSSG switching. In PDCCH skipping, the UE 115 may stop monitoring PDCCH for a configured duration (e.g., in slots, in milliseconds (ms)). An SSS may indicate a set of control channel element (CCE) locations (e.g., PDCCH occasions) where the UE 115 may monitor PDCCH to receive DCI. An SSSG may be a group of SSSs associated with an index or other identifier. In SSSG switching, the UE 115 may switch between monitored SSSGs. For instance, the UE 115 may stop monitoring a first SSSG and may begin monitoring a second SSSG and a third SSSG. Such power states may further adapt one or more monitoring parameters, such as a periodicity, a monitoring density, a quantity of monitoring occasions, a quantity of search space sets, a quantity of SSSGs, a duration (e.g., a monitoring duration, a duration for operating in the power state), a DCI format, or a combination thereof. For example, reducing a quantity of monitoring occasions may reduce power consumption at a wireless device.

According to the techniques described herein, a wireless device may utilize a set of codepoints to indicate one or more power states. A network entity 105 may configure a mapping between each power state of a set of power states and a respective codepoint of the set of codepoints. The network entity 105 may transmit a first message (e.g., a control message, such as an RRC message) to a UE 115 to indicate the mapping. Each power state may correspond to a respective directional communication profile associated with the network entity 105, the UE 115, or both. The network entity 105 may transmit a second message (e.g., a second control message, such as DCI or MAC-CE) to the UE 115 to indicate a codepoint from the set of codepoints. The codepoint may correspond to a power state associated with a directional communication profile for communications at the UE 115. For instance, when the UE 115 operates according to uplink-only communications, the network entity 105 may indicate a codepoint corresponding to an uplink-only power state. The UE 115 may transition to the uplink-only power state in response to receiving the indication of the codepoint and in accordance with the mapping. In the uplink-only power state, the UE 115 may pause monitoring of one or more downlink channels, which may conserve power at the UE 115. Additionally, or alternatively, the network entity 105 may operate in accordance with the power state at the UE 115, e.g., by pausing transmission of the one or more downlink channels.

In some cases, a codepoint may be included in a field associated with SSSG switching indications. The network entity 105 may activate the mapping between the set of codepoints and the set of power states for the SSSG switching indication field. That is, the set of codepoints may initially be mapped to SSSG switching behaviors, and the network entity 105 may activate the mapping such that the codepoints correspond to power states (e.g., instead of the SSSG switching behaviors). The network entity 105 may transmit, to the UE 115, an indication that the mapping between the set of codepoints and the set of power states is activated. Additionally, the network entity 105 may deactivate the mapping such that the codepoints no longer correspond to the set of power states. After deactivation, the codepoints may again be mapped to the SSSG switching behaviors.

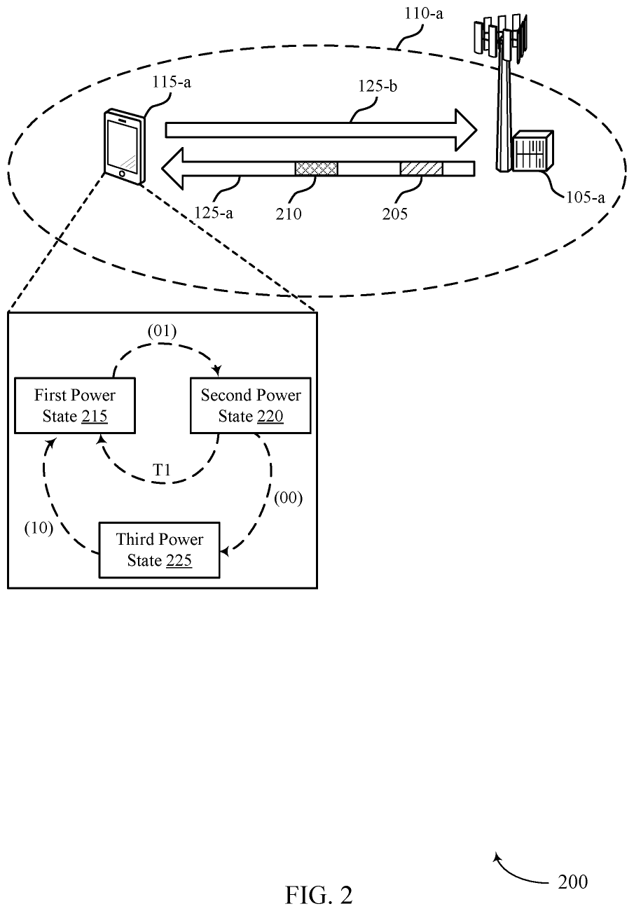

FIG. 2 shows an example of a wireless communications system 200 that supports techniques for indicating communication power states in accordance with one or more aspects of the present disclosure. For example, the wireless communications system 200 may include one or more network entities 105 (e.g., a network entity 105-a) and one or more UEs 115 (e.g., a UE 115-a), which may be examples of the corresponding devices as described with reference to FIG. 1. The wireless communications system 200 may support the use of codepoints to indicate one or more power states according to a mapping between the codepoints and the one or more power states.

In the wireless communications system 200, the UE 115-a and the network entity 105-a may communicate via one or more communication links 125 in a coverage area 110-a. For example, the network entity 105-a may transmit downlink signals via a communication link 125-a, which may include or be an example of a downlink communication link (e.g., PDCCH, physical downlink shared channel (PDSCH)). The UE 115-a may monitor the communication link 125-a to detect, receive, and decode the downlink signals. Additionally, or alternatively, the UE 115-a may transmit uplink signals to the network entity 105-a via a communication link 125-b, which may include or be an example of an uplink communication link (e.g., physical uplink control channel (PUCCH), physical uplink shared channel (PUSCH)). The network entity 105-a may monitor the communication link 125-b to detect, receive, and decode the uplink signals.

According to the techniques described herein, the wireless communications system 200 may support transition of the UE 115-a (and, in some cases, the network entity 105-a) between multiple power states (e.g., N power states), where each power state of the multiple power states corresponds to a respective directional communication profile of the UE 115-a. The multiple power states may include, but are not limited to, an uplink-only power state (e.g., an uplink only-configured grant power state, an uplink only-dynamic grant power state), a downlink-only power state, a downlink semi-persistent scheduling (SPS) power state, an uplink-and-downlink power state (e.g., a normal power state), a modem off power state, a high-rate power state (e.g., a downlink high-rate power state, an uplink high-rate power state), a low-rate power state (e.g., a downlink low-rate power state, an uplink low-rate power state), or any combination thereof. For example, the multiple power states may include at least one power state that is associated with uplink communications (e.g., uplink-only communications), at least one power state that is associated with downlink communications (e.g., downlink-only communications), and at least one power state that is associated with both uplink and downlink communications. In some examples, the multiple power states may be associated with multiple CCs (e.g., according to one or more power state patterns).

For illustrative purposes, the multiple power states in the context of FIG. 2 may include a first power state 215, a second power state 220, and a third power state 225, each of which may be any power state or any combination of power states described herein. Although the wireless communications system 200 illustrates a configuration of three power states (e.g., the first power state 215, the second power state 220, and the third power state 225), it is to be understood that any wireless device or combination of wireless devices may be configured to cycle between any quantity or combination of power states.

Each directional communication profile may correspond to one or more communication parameters that configure the UE 115-a to communicate in a respective communication direction and according to a respective traffic profile. For example, each directional communication profile may indicate or otherwise be associated with a BWP for a primary cell, a dormant BWP for the primary cell, one or more BWPs for one or more secondary cells, a dormant BWP for the one or more secondary cells, or a combination thereof. Additionally, or alternatively, each directional communication profile may be associated with restricted reception of a data channel, a control channel, or both, in the BWP for the primary cell, the one or more BWPs for the one or more secondary cells, or some combination thereof.

Additionally, each power state and each directional communication profile may be associated with a configuration of the UE 115-a that enables the UE 115-a to operate according to one or more behaviors. As an illustrative example in the context of FIG. 2, the first power state 215 may be associated with a first directional communication profile and a first configuration of the UE 115-a, the second power state 220 may be associated with a second directional communication profile and a second configuration of the UE 115-a, and the third power state 225 may be associated with a third directional communication profile and a third configuration of the UE 115-a. Moreover, each power state (e.g., each directional communication profile) may be associated with a power consumption (e.g., an expected power level consumption). For example, the first power state 215 may be associated with a first power consumption level, the second power state 220 may be associated with a second power consumption level, and the third power state 225 may be associated with a third power consumption level, where the first power consumption level is less than the second power consumption level and the second power consumption level is less than the third power consumption level.

In some examples, the first directional communication profile, the second directional communication profile, the third directional communication profile, or any combination thereof, may indicate restricted reception or transmission of a single type of data traffic or of multiple types of data traffic to flexibly allocate modem power states for the UE 115-a and to reduce power consumption by the UE 115-a. Thus, each directional communication profile may be tailored to an expected traffic environment (e.g., an amount of traffic, one or more traffic directions, a data rate, a throughput), or a lack thereof, at the UE 115-a, such that the UE 115-a is configured to perform the one or more behaviors.

For example, an uplink-only configured grant power state may be associated with a configuration of the UE 115-a in which the UE 115-a refrains from monitoring for downlink transmissions (e.g., via PDCCH and PDSCH), reduces a frequency of retransmissions (e.g., as compared to the uplink-and-downlink power state), may dormant one or more BWPs associated with additional cells (e.g., additional network entities 105) of the UE 115-a, and may perform uplink positioning. In another example, an uplink-only dynamic grant power state may be associated with a configuration of the UE 115-a in which the UE 115-a refrains from monitoring for downlink transmissions associated with scheduling downlink transmissions (e.g., downlink DCI messages) and may monitor a downlink control channel for downlink transmissions associated with scheduling uplink transmissions (e.g., uplink grants).

Additionally, or alternatively, a downlink-only power state may be associated with a configuration of the UE 115-a in which the UE 115-a monitors for downlink transmissions and refrains from transmitting uplink control messages (e.g., DCI messages). In some examples, the UE 115-a may transmit scheduling requests (e.g., conditional scheduling requests) while operating in the downlink-only power state. Additionally, or alternatively, a downlink SPS power state may be associated with a configuration of the UE 115-a in which the UE 115-a monitors for transmissions associated with an SPS configuration.

An uplink-and-downlink power state may be associated with a configuration of the UE 115-a in which the UE 115-a monitors for both uplink transmissions and downlink transmissions. Additionally, the uplink-and-downlink power state may be associated with relatively densely-configured communications, such as reference signals, wake-up signal (WUS) occasions, or other examples. A modem-off power state may be associated with a configuration of the UE 115-a in which the UE 115-a sleeps or idles, and in which SSSGs are configured to be empty, WUSs are deactivated, and the UE 115-a does not transmit or receive signals.

In the example of FIG. 2, the first power state 215 may be an example of a modem-off power state, the second power state 220 may be an example of an uplink-only power state, and the third power state 225 may be an example of an uplink-and-downlink power state. When a power state corresponds to a directional communication profile having restricted reception or transmission of a directional channel, the UE 115-a may reduce power consumption by turning off one or more modems (e.g., transmission or reception circuitry) that are not used by the UE 115-a for communications via the directional channel. While operating in the first power state 215, for instance, the UE 115-a may turn off multiple (e.g., all) modems. In some cases, the first power state 215 may correspond to an idle or sleep state. Thus, the UE 115-a may consume less power during operations in the first power state 215 than in the second power state 220 or the third power state 225.

As illustrated in FIG. 2, the second directional communication profile may correspond to reduced or restricted downlink data traffic at the UE 115-a. Thus, the second directional communication profile may indicate restricted reception of a downlink shared channel, a downlink control channel, or both. The UE 115-a may turn off one or more modems associated with downlink traffic reception while operating in the second power state 220 (e.g., an uplink-only power state). Alternatively, in other examples, the second directional profile may correspond to reduced or restricted uplink data traffic at the UE 115-a, and may indicate restricted transmission of an uplink shared channel, an uplink control channel, or both. In such examples, the UE 115-a may turn off one or more modems associated with uplink traffic transmission while operating in the second power state 220 (e.g., a downlink-only power state). In either example, based on restricted reception or transmission of one or more channels, the second power state 220 may provide for the UE 115-a to support one or more applications that are associated with relatively stringent QoS requirements, such as latency requirements (e.g., periodic low latency power constrained traffic (LLPCT), or traffic for other applications associated with relatively frequent transmission or low latency), while reducing power consumption at the UE 115-a.

The third directional communication profile may not correspond to restricted data traffic at the UE 115-a. Accordingly, while operating in the third power state 225, the UE 115-a may communicate via one or more downlink channels and one or more uplink channels During operation in the third power state 225, the UE 115-a may refrain from turning off any modems. The third power state 225 and the third directional communication profile may thus be utilized for relatively high throughput at the UE 115-a, or for scenarios in which the UE 115-a is capable of supporting relatively high power consumption.

The network entity 105-a may configure the UE 115-a with the multiple power states (e.g., with the first power state 215, the second power state 220, and the third power state 225). For example, the network entity 105-a may indicate the multiple power states to the UE 115-a as part of a control message (e.g., RRC signaling) via the communication link 125-a. The control message may indicate the multiple power states, one or more parameters (e.g., of an associated configuration of the UE 115-a) corresponding to each power state of the multiple power states, or some combination thereof. Although the wireless communications system 200 illustrates a configuration of three power states (e.g., the first power state 215, the second power state 220, and the third power state 225), it is to be understood that the techniques described herein may be applied to any quantity or configuration of power states.

Additionally, or alternatively, the network entity 105-a may configure a mapping between the multiple power states and a set of codepoints, such that each power state corresponds to a respective codepoint of the set of codepoints. Each codepoint may include or be an example of a set of bits mapped to a respective power state of the multiple power states, where each set of bits may include a quantity of bits. An example mapping between the first power state 215, the second power state 220, and the third power state 225, and a set of codepoints, is illustrated below in Table 1. While each codepoint in Table 1 includes a set of two bits, it is to be understood that other quantities or combinations of bits and other quantities or combinations of codepoints may be implemented, and the example shown should not be construed as limiting.

TABLE 1
Codepoint-to-Power State Mapping

| Codepoint | Power State |
|---|---|
| 10 | First Power State 215 |
| 01 | Second Power State 220 |
| 00 | Third Power State 225 |

The network entity 105-a may transmit an indication of the mapping (e.g., an indication of Table 1) to the UE 115-a within a downlink control message 205. The downlink control message 205 may include or be an example of an RRC message.

To activate a power state at the UE 115-a, the network entity 105-a may transmit a second downlink control message (e.g., DCI, MAC-CE), such as a downlink control message 210, to the UE 115-a that includes a codepoint from the set of codepoints. The UE 115-a may transition to the power state corresponding to the indicated codepoint based on receiving the downlink control message 210. Thus, a downlink control message including a codepoint may implicitly indicate activation of a power state corresponding to the codepoint, e.g., in accordance with the mapping. That is, inclusion of a codepoint corresponding to a power state in the downlink control message 210 may indicate activation of the power state at the UE 115-a, the network entity 105-a, or both. The network entity 105-a may operate in accordance with the indicated power state. For example, the network entity 105-a may operate in the indicated power state or may communicate with the UE 115-a according to the indicated power state at the UE 115-a.

The network entity 105-a may include a codepoint in the downlink control message 210 based on traffic at the UE 115-a. Here, the network entity 105-a may determine a power state to activate for the UE 115-a that corresponds to a directional communication profile associated with traffic at the UE 115-a, and may include, in the downlink control message 210, a codepoint corresponding to the power state in accordance with the mapping. In some examples, the first power state 215 (e.g., and the corresponding first directional communication profile), the second power state 220 (e.g., and the corresponding second directional communication profile), the third power state 225 (e.g., and the corresponding third directional communication profile), or a combination thereof may be defined (e.g., pre-defined or pre-configured). By utilizing a codepoint-to-power state mapping as described herein, the network entity 105-a may dynamically activate or deactivate power states at the UE 115-a based on directional communication profiles at the UE 115-a.

The UE 115-a may transition between power states to increase power savings, meet a QoS threshold for a given directional communication profile, or both. More specifically, the UE 115-a may transition between power states based on receiving downlink control messages (e.g., DCI, MAC-CE) from the network entity 105-a, based on satisfying one or more conditions, or a combination thereof. In some examples, the condition may be satisfied based on the UE 115-a initiating a retransmission timer, transmitting a negative acknowledgment message for one or more downlink messages, operating in an activation period of a power state, receiving a burst of downlink messages, receiving a second control message indicating a power state, expiration of a timer, or any combination thereof.

For example, the UE 115-a may transition between power states based on receiving a downlink control message (e.g., a DCI message) indicating a codepoint, such as the downlink control message 210, where the downlink control message 210 activates a power state at the UE 115-a. The UE 115-a may receive the downlink control message 210 indicating a codepoint (10) corresponding to the first power state 215. Based on receiving the downlink control message 210, and in accordance with the mapping, the UE 115-a may transition to (e.g., operate in) the first power state 215. Over time, traffic at the UE 115-a may change, and the network entity 105-a may transmit another downlink control message 210 to activate a different power state at the UE 115-a. The downlink control message 210 may indicate that the UE 115-a is to transition to a power state different from the first power state 215 based on a current or updated directional communication profile at the UE 115-a. That is, the network entity 105-a may transmit, and the UE 115-a may receive, a second downlink control message including a second codepoint, such as a codepoint (01) corresponding to the second power state 220. Inclusion of the codepoint (01) in the second downlink control message may indicate (e.g., implicitly indicate) activation of the second power state 220 at the UE 115-a. As such, the UE 115-a may transition from the first power state 215 to the second power state 220 based on receiving the second downlink control message.

Additionally, or alternatively, each power state may correspond to a timer. The network entity 105-a may configure a respective timer for each power state of the multiple power states. In some cases, the network entity 105-a may indicate, to the UE 115-a, a set of timers corresponding to the multiple power states via control signaling, such as the downlink control message 205 (e.g., the UE 115-a may be RRC-configured with the timers for the multiple power states). In some examples, the network entity 105-a may dynamically adapt one or more timers of the set of timers according to a directional traffic periodicity (e.g., uplink traffic periodicity, downlink traffic periodicity) or to align with a beginning of an on duration (e.g., a connected mode discontinuous reception (CDRX) on duration). In other examples, the set of timers may be associated with SSSG skipping, but the UE 115-a may be configured to use the set of timers for the multiple power states (e.g., in addition to or instead of SSSG skipping).

As an illustrative example, the UE 115-a may operate in the first power state 215 based on receiving the downlink control message 210 indicating the codepoint (10). The UE 115-a may receive a second control message that includes a codepoint (01) corresponding to the second power state 220. The second power state 220 may be associated with a timer T1. The UE 115-a may initiate the timer T1 and transition to the second power state 220 based on receiving the second control message. The UE 115-a may operate in the second power state 220 for the duration of the timer T1, e.g., until the timer T1 expires. After expiry of the timer T1, the UE 115-a may transition to (e.g., back to) the first power state 215.

Alternatively, the UE 115-a may transition between power states at periodic times, e.g., according to a power state pattern, a periodic cycle, or a set of activation periods. For instance, each power state may be associated with one or more timers and one or more activation periods. The UE 115-a may transition from the first power state 215 to the second power state 220 based on the UE 115-a transitioning to an activation period associated with the second power state 220. The UE 115-a may initiate a first timer T1 associated with the activation period based on transitioning to the second power state 220 during the activation period. Additionally, the UE 115-a may transition from the second power state 220 to (e.g., back to) the first power state 215 based on expiration of the first timer T1. In some other examples, the UE 115-a may transition between power states based on activation periods or timers associated with each power state according to periodicity of uplink traffic, downlink traffic, or both.

In another example, the UE 115-a may transition between power states based on transmission of a burst of downlink messages, scheduling of the burst of downlink messages, or both. For example, the UE 115-a may receive a downlink control message 210 scheduling a burst of downlink messages and may transition from the second power state 220 to the third power state 225 based on receiving the downlink control message 210 scheduling the burst of downlink messages, e.g., so that the UE 115-a may receive the scheduled burst of downlink messages while in the third power state 225. Additionally, or alternatively, the UE 115-a may receive the burst of downlink messages and may transition from the second power state 220 to the third power state 225 based on receiving the burst of downlink messages (e.g., the UE 115-a may transition after or at the end of the burst of downlink messages).

In some cases, the UE 115-a may transition from one power state to another power state based on initiating a retransmission timer or transmitting one or more negative acknowledgment messages. For example, the UE 115-a may initiate a retransmission timer and may transmit one or more negative acknowledgment messages based on failing to receive, failing to decode, or both, one or more downlink messages. The UE 115-a may transition from a first power state to a second power state based on initiating the retransmission timer, based on transmitting the one or more negative acknowledgement messages, or both. In yet another example, the UE 115-a may transition between power states based on a buffer of the UE 115-a falling below a threshold.

In some examples, a power state may include or be an example of a monitoring adaptation mechanism, such as PDCCH skipping or SSSG switching. For example, the UE 115-a may be configured with multiple search space sets and multiple SSSGs. The network entity 105-a may transmit a downlink control message (e.g., DCI), such as the downlink control message 210, to indicate that the UE 115-a is to refrain from (e.g., stop) monitoring one or more SSSGs or is to switch monitoring from a first one or more SSSGs to a second one or more SSSGs. Additionally, or alternatively, the downlink control message may indicate that the UE 115-a is to refrain from (e.g., stop) PDCCH monitoring for a corresponding time duration X, e.g., up to 100 ms. The time duration X may be configured per BWP. In some cases, the time duration X may be indicated (e.g., within the downlink control message) as a quantity of slots and may be based on a subcarrier spacing (SCS) of the UE 115-a, as illustrated in Table 2 below.

TABLE 2
PDCCH Skipping Durations

| SCS | Time Duration X (slots) |
|---|---|
| 15 kHz | {1, 2, 3, . . . , 20, 30, 40, 50, 60, 80, 100} |
| 30 kHz | {1, 2, 3, . . . , 40, 60, 80,100, 120, 160, 200} |
| 60 kHz | {1, 2, 3, . . . , 80, 120, 160, 200, 240, 320, 400} |
| 120 kHz | {1, 2, 3, . . . , 160, 240, 320, 400, 480, 640, 800} |

A field within the downlink control message may be configured for indicating SSSG switching and PDCCH skipping, and a set of codepoints mapped to one or more SSSG switching/PDCCH skipping behaviors may be configured for inclusion in the field. In some examples, the network entity 105-a may repurpose an SSSG switching indication (e.g., the field within the DCI and the set of codepoints) to instead indicate the multiple power states. That is, the network entity 105-a may repurpose the set of codepoints by mapping the set of codepoints to the multiple power states (e.g., instead of to the one or more SSSG switching/PDCCH skipping behaviors) and including a codepoint from the set of codepoints in the field within the DCI to indicate a respective power state of the multiple power states. In such cases, the network entity 105-a may additionally repurpose a set of timers associated with SSSG switching for use with the multiple power states. The network entity 105-a may indicate the repurposing of the set of timers to the UE 115-a as part of the downlink control message.

In some cases, when the set of codepoints is mapped to the multiple power states, the set of codepoints may include an additional codepoint that is mapped to a PDCCH skipping operation. That is, a codepoint of the set of codepoints may be used to indicate PDCCH skipping in addition to the multiple power states. An example set of codepoints mapped to a set of power states and a PDCCH skipping operation is illustrated in Table 3 below.

TABLE 3
Codepoint-to-Power State Mapping with PDCCH Skipping

| Codepoint | Power State |
|---|---|
| 00 | Uplink-and-downlink |
| 01 | Uplink only |
| 10 | Modem off |
| 11 | PDCCH skipping for duration X |

A first operation mode may correspond to the network entity 105-a using the field and the set of codepoints to indicate monitoring adaptation mechanisms (e.g., SSSG switching, PDCCH skipping) and a second operation mode may correspond to the network entity 105-a using the field and the set of codepoints to indicate the multiple power states. In the second operation mode, the network entity 105-a may configure an association (e.g., mapping) between the codepoints (e.g., bits) and the multiple power states and may use the set of codepoints to indicate the multiple power states instead of to indicate the SSSG switching/PDCCH skipping behaviors. For example, in the first operation mode, the codepoint (10) may correspond to a behavior in which the UE 115-a stops monitoring a first SSSG and a second SSSG and begins monitoring a third SSSG. In the second operation mode, the codepoint (01) may instead be mapped to the first power state 215. The network entity 105-a may activate or deactivate the second operation mode by activating or deactivating (e.g., enabling or disabling) the association between the codepoints and the multiple power states.

In some examples, the network entity 105-a may transmit (e.g., via dynamic signaling or semi-static signaling), to the UE 115-a, an indication that the codepoint is associated with a power state instead of with an SSSG switching indication. Additionally, or alternatively, the network entity 105-a may transmit (e.g., via dynamic signaling or semi-static signaling), to the UE 115-a, an indication of an activation state (e.g., an activated state, a deactivated state), or a change in the activation state, of the mapping between the set of codepoints and the multiple power states. In the latter example, the UE 115-a may interpret a received codepoint according to the indication of the activation state. Put another way, behavior of the UE 115-a may be based on the activation state (e.g., the second operation mode). For example, the UE 115-a may receive a control message (e.g., DCI, MAC-CE, RRC signaling) indicating that the activation state is an activated state. When the UE 115-a receives the downlink control message 210 including a codepoint, the UE 115-a may determine a power state corresponding to the codepoint based on the mapping between the set of codepoints and the multiple power states.

For instance, when the activation state is an activated state, the UE 115-a may expect communications in a given direction or may monitor for a particular DCI format, e.g., according to an indicated codepoint and corresponding power state. In an uplink-and-downlink power state, the UE 115-a may monitor a downlink channel (e.g., PDCCH) for both uplink DCI and downlink DCI. During operation in a modem off state, the UE 115-a may not monitor for DCI. In this example, the UE 115-a may be configured with an empty SSSG that is not associated with any PDCCH candidates. If the UE 115-a receives an indication to monitor an SSSG (e.g., the second SSSG), the UE 115-a may skip PDCCH monitoring for a configured duration.

In an uplink-only power state, the UE 115-a may only monitor for uplink DCI and may not expect to search for DCI formats corresponding to downlink communications (e.g., downlink grants). Alternatively, in a downlink-only power state, the UE 115-a may only monitor for downlink DCI and may not expect to search for DCI formations corresponding to uplink communications (e.g., uplink grants). In either case, monitoring restrictions associated with a power state may apply to all SSSs in an SSSG. Thus, the UE 115-a may monitor for only one of an uplink scheduling DCI or a downlink scheduling DCI based on a corresponding power state of the UE 115-a.

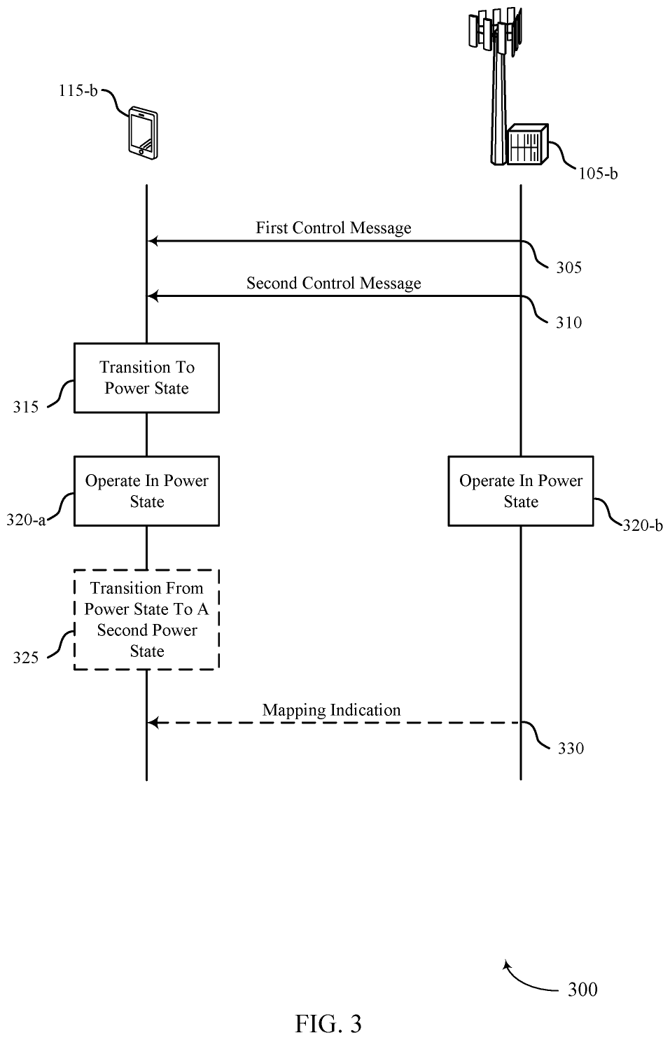

FIG. 3 shows an example of a process flow 300 that supports techniques for indicating communication power states in accordance with one or more aspects of the present disclosure. In some examples, the process flow 300 may implement or be implemented by aspects of the wireless communications system 100 or the wireless communications system 200. For example, the process flow 300 may include one or more network entities 105 (e.g., a network entity 105-b) and one or more UEs 115 (e.g., a UE 115-b), which may be examples of the corresponding devices as described with reference to FIG. 1. The process flow 300 may support transition of the UE 115-b between multiple power states, where each power state of the multiple power states corresponds to a respective configuration of the UE 115-b, a respective configuration of the network entity 105-b, or a combination thereof.

At 305, the network entity 105-b may transmit, and the UE 115-b may receive, a first control message that indicates a mapping between a set of power states and a set of codepoints. For example, the mapping may be between individual power states of the set of power states and respective codepoints of the set of codepoints. Each power state may correspond to a respective direction communication profile associated with the UE. In some cases, the mapping may include an additional codepoint that is mapped to a PDCCH skipping operation. Additionally, or alternatively, the first control message may indicate a set of timers corresponding to the set of power states. The set of timers may be associated with SSSG switching.

The set of power states may include, but is not limited to, a modem-off power state, one or more uplink-only power states corresponding to one or more uplink communication rates, one or more downlink-only power states corresponding to one or more downlink communication rates, an uplink-and-downlink power state, or some combination thereof.

Each respective direction communication profile may be associated with one or more of a BWP for a primary cell, one or more BWPs for one or more secondary cells, a dormant BWP for the primary cell, a dormant BWP for the one or more secondary cells, restricted reception of a data channel in the BWP for the primary cell, restricted reception of a control channel in the BWP for the primary cell, restricted reception of the data channel in the one or more BWPs for the one or more secondary cells, restricted reception of the control channel in the one or more BWPs for the one or more secondary cells, or a combination thereof.

At 310, the network entity 105-b may transmit, and the UE 115-b may receive, a second control message that includes a codepoint from the set of codepoints. The codepoint may correspond to a power state from the set of power states, e.g., according to the mapping indicated at 305. The network entity 105-b may include the codepoint in the second control message to indicate activation of the power state (e.g., at the UE 115-b, at the network entity 105-b, or both).

In some examples, the second control message may include the codepoint within a field associated with an SSSG indication, such as an SSSG switching indication. In such examples, the network entity 105-b may transmit, and the UE 115-b may receive, an indication that the codepoint is associated with the power state instead of with the SSSG indication (e.g., that the codepoint indicates the power state instead of indicating the SSSG).

At 315, the UE 115-b may transition to the power state indicated by the codepoint included within the second control message.

At 320-a and 320-b, the UE 115-b and the network entity 105-b, respectively, may operate in the power state. In some cases, the UE 115-b and the network entity 105-b may communicate, or refrain from communicating, via one or more communication links in accordance with the power state. For example, the power state may be an uplink-only power state. During operation in the uplink-only power state, the UE 115-b may pause monitoring of a downlink shared channel (e.g., PDSCH). The network entity 105-b may pause transmission of the downlink shared channel. The network entity 105-b may transmit, via a downlink control channel (e.g., PDCCH), an uplink configured grant that indicates one or more sets of periodic uplink resources for the UE 115-b. The UE 115-b may monitor the downlink control channel or the uplink configured grant. The UE 115-b may transmit, and the network entity 105-b may receive, an uplink message (e.g., to the network entity 105-b) in accordance with the uplink configured grant.

In another example, the power state may be a downlink-only power state. Here, the UE 115-b may pause transmission of at least one of an uplink control channel (e.g., PUCCH) and an uplink shared channel (e.g., PUSCH). The network entity 105-b may pause monitoring of the uplink control channel, the uplink shared channel, or both. The network entity 105-b may transmit, via a downlink control channel (e.g., PDCCH), a downlink configured grant that indicates one or more downlink resources. The UE 115-b may monitor the downlink control channel for the downlink configured grant. Additionally, the network entity 105-b may transmit, via a downlink shared channel (e.g., PDSCH), a downlink message in accordance with the downlink configured grant. The UE 115-b may monitor the downlink shared channel for the downlink message based on the downlink configured grant.

In yet another example, the power state may be an uplink-and-downlink power state. In such states, the UE 115-b may monitor a downlink control channel (e.g., PDCCH) for a downlink configured grant, an uplink configured grant, or both. The network entity 105-b may transmit the downlink configured grant, the uplink configured grant, or both, via the downlink control channel.

Alternatively, the power state may be a modem-off power state. During operation in the modem-off power state, the UE 115-b may pause monitoring of a downlink control channel (e.g., PDCCH) and monitoring of a downlink shared channel (e.g., PDSCH). The network entity 105-b may pause transmission of the downlink control channel and transmission of the downlink shared channel. Additionally, the UE 115-b may pause transmission of an uplink control channel (e.g., PUCCH) and transmission of an uplink shared channel (e.g., PUSCH), and the network entity 105-b may pause monitoring of the uplink control channel and monitoring of the uplink shared channel.

At 325, in some examples, the UE 115-b may transition from the power state to a second power state of the set of power states. For example, when the first control message indicates a set of timers corresponding to the set of power states, the UE 115-b may transition to the second power state based on expiry of a timer of the set of timers, the timer associated with the second power state.

At 330, in some cases, the network entity 105-b may transmit, and the UE 115-b may receive, an indication that changes an activation state of the mapping between the set of power states and the set of codepoints. The activation state may be an activated state or a deactivated state.

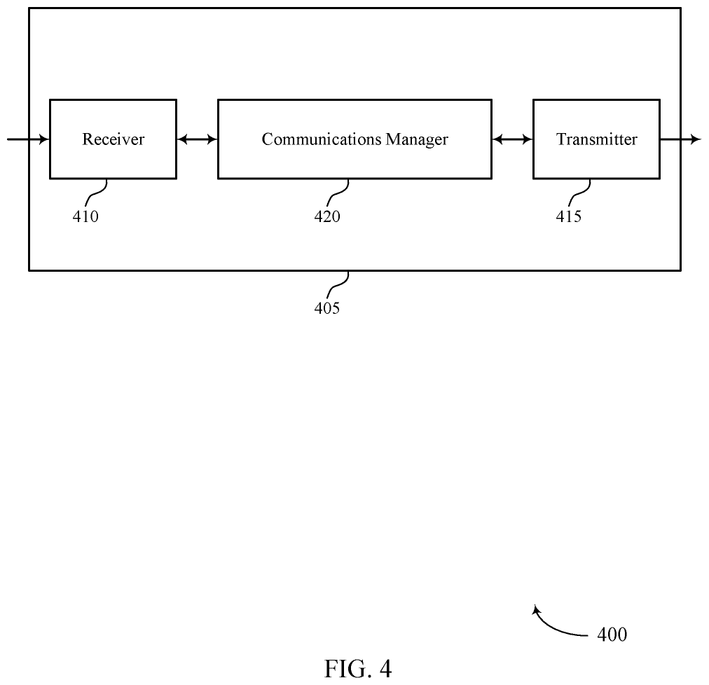

FIG. 4 shows a block diagram 400 of a device 405 that supports techniques for indicating communication power states in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for indicating communication power states). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for indicating communication power states). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for indicating communication power states as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software) executed by a processor. If implemented in code executed by a processor, the functions of the communications manager 420, the receiver 410, the transmitter 415, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 is capable of, configured to, or operable to support a means for receiving a first control message that indicates a mapping between individual ones of a set of power states and respective ones of a set of codepoints, each power state of the set of power states being for the UE or a network entity in communication with the UE and corresponding to a respective directional communication profile associated with the UE. The communications manager 420 is capable of, configured to, or operable to support a means for receiving a second control message that includes a codepoint from the set of codepoints, the codepoint corresponding to a power state from the set of power states in accordance with the mapping, inclusion of the codepoint in the second control message indicative of activation of the power state at the UE. The communications manager 420 is capable of, configured to, or operable to support a means for transitioning to the power state in accordance with the second control message.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced processing and reduced power consumption. For example, by configuring the device 405 with multiple power states, the device 405 may be capable of adaptively operating according to tradeoffs between power consumption and performance, which may reduce processing, reduce latency, and conserve battery. Further, by utilizing a mapping between codepoints and power states, the device 405 may more efficiently switch between power states. For example, the device 405 may receive a codepoint corresponding to a power state associated with relatively low power consumption, such as a first power state. To transition to the first power state, a processor of the device 405 may turn off one or more modems of the device 405, transmit or receive less data, or both, which may reduce processing and power consumption.

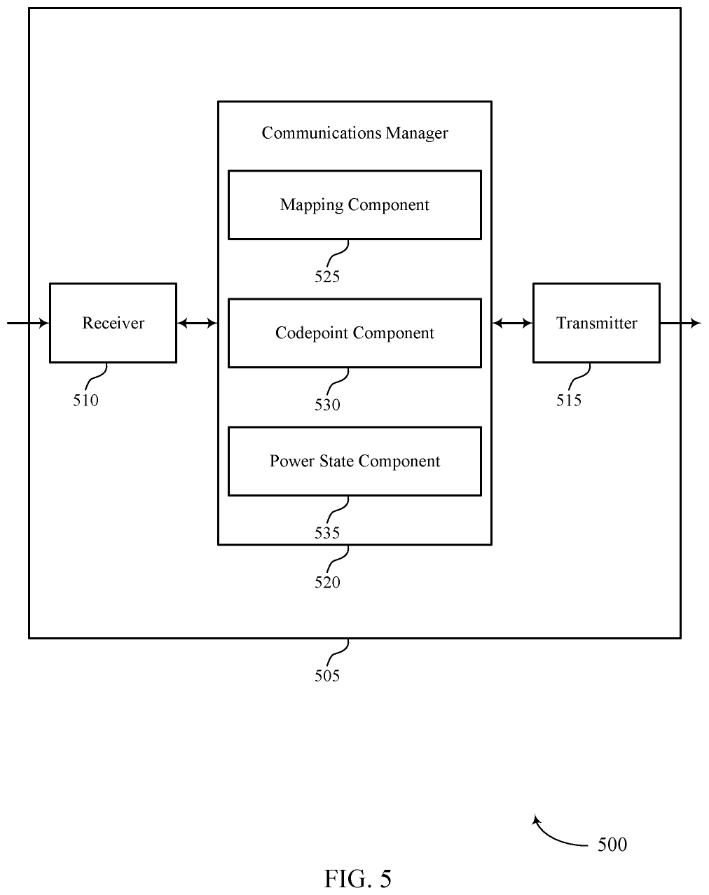

FIG. 5 shows a block diagram 500 of a device 505 that supports techniques for indicating communication power states in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for indicating communication power states). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for indicating communication power states). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for indicating communication power states as described herein. For example, the communications manager 520 may include a mapping component 525, a codepoint component 530, a power state component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The mapping component 525 is capable of, configured to, or operable to support a means for receiving a first control message that indicates a mapping between individual ones of a set of power states and respective ones of a set of codepoints, each power state of the set of power states being for the UE or a network entity in communication with the UE and corresponding to a respective directional communication profile associated with the UE. The codepoint component 530 is capable of, configured to, or operable to support a means for receiving a second control message that includes a codepoint from the set of codepoints, the codepoint corresponding to a power state from the set of power states in accordance with the mapping, inclusion of the codepoint in the second control message indicative of activation of the power state at the UE. The power state component 535 is capable of, configured to, or operable to support a means for transitioning to the power state in accordance with the second control message.

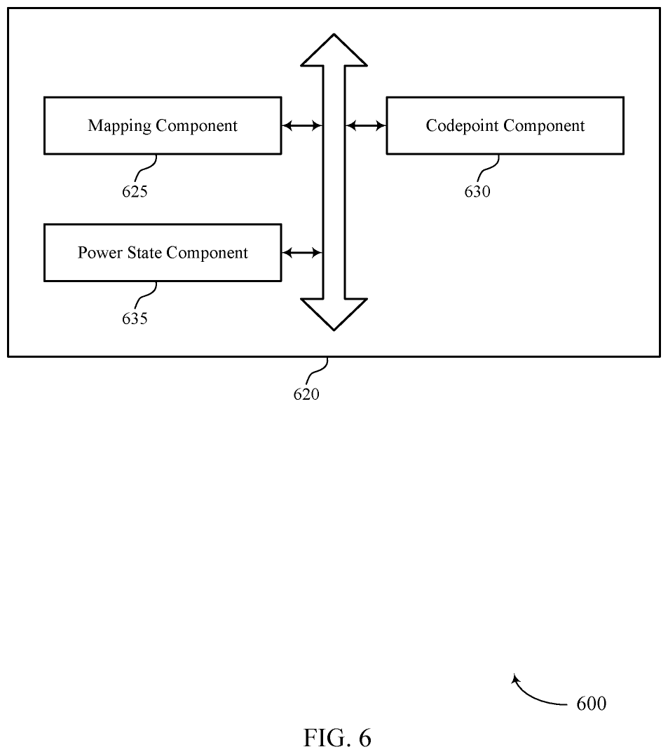

FIG. 6 shows a block diagram 600 of a communications manager 620 that supports techniques for indicating communication power states in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for indicating communication power states as described herein. For example, the communications manager 620 may include a mapping component 625, a codepoint component 630, a power state component 635, or any combination thereof. Each of these components may communicate, directly or indirectly, with one another (e.g., via one or more buses).

The communications manager 620 may support wireless communications at a UE in accordance with examples as disclosed herein. The mapping component 625 is capable of, configured to, or operable to support a means for receiving a first control message that indicates a mapping between individual ones of a set of power states and respective ones of a set of codepoints, each power state of the set of power states being for the UE or a network entity in communication with the UE and corresponding to a respective directional communication profile associated with the UE. The codepoint component 630 is capable of, configured to, or operable to support a means for receiving a second control message that includes a codepoint from the set of codepoints, the codepoint corresponding to a power state from the set of power states in accordance with the mapping, inclusion of the codepoint in the second control message indicative of activation of the power state at the UE. The power state component 635 is capable of, configured to, or operable to support a means for transitioning to the power state in accordance with the second control message.

In some examples, the second control message includes the codepoint within a field associated with a SSSG switching indication, and the codepoint component 630 is capable of, configured to, or operable to support a means for receiving an indication that the codepoint is associated with the power state instead of with a SSSG switching indication.

In some examples, the mapping component 625 is capable of, configured to, or operable to support a means for receiving an indication that changes an activation state of the mapping between the individual ones of the set of power states and the respective ones of the set of codepoints, where the activation state is one of an activated state or a deactivated state.

In some examples, the respective directional communication profile is associated with one or more of a BWP for a primary cell, one or more BWPs for one or more secondary cells, a dormant BWP for the primary cell, a dormant BWP for the one or more secondary cells, restricted reception of a data channel in the BWP for the primary cell, restricted reception of a control channel in the BWP for the primary cell, restricted reception of the data channel in the one or more BWPs for the one or more secondary cells, restricted reception of the control channel in the one or more BWPs for the one or more secondary cells, or a combination thereof.

In some examples, the set of power states includes a modem-off power state, one or more uplink-only power states corresponding to different uplink communication rates, one or more downlink-only power states corresponding to different downlink communication rates, an uplink-and-downlink power state, or combinations thereof.

In some examples, the power state includes a modem-off power state, and the power state component 635 is capable of, configured to, or operable to support a means for pausing, while operating in the power state, a monitoring of a downlink control channel and a downlink shared channel. In some examples, the power state includes a modem-off power state, and the power state component 635 is capable of, configured to, or operable to support a means for pausing, while operating in the power state, transmission of an uplink control channel and an uplink shared channel.

In some examples, the power state includes an uplink-only power state, and the power state component 635 is capable of, configured to, or operable to support a means for pausing, while operating in the power state, a monitoring of a downlink shared channel. In some examples, the power state includes an uplink-only power state, and the power state component 635 is capable of, configured to, or operable to support a means for monitoring, while operating in the power state, a downlink control channel for an uplink configured grant indicating one or more sets of periodic uplink resources. In some examples, the power state includes an uplink-only power state, and the power state component 635 is capable of, configured to, or operable to support a means for transmitting, while operating in the power state, an uplink message in accordance with the uplink configured grant.

In some examples, the power state includes a downlink-only power state, and the power state component 635 is capable of, configured to, or operable to support a means for pausing, while operating in the power state, transmission of at least one of an uplink control channel and an uplink shared channel. In some examples, the power state includes a downlink-only power state, and the power state component 635 is capable of, configured to, or operable to support a means for monitoring, while operating in the power state, a downlink control channel for a downlink configured grant indicating one or more downlink resources. In some examples, the power state includes a downlink-only power state, and the power state component 635 is capable of, configured to, or operable to support a means for monitoring, while operating in the power state, a downlink shared channel for a downlink message in accordance with the downlink configured grant.

In some examples, the power state includes an uplink-and-downlink power state, and the power state component 635 is capable of, configured to, or operable to support a means for monitoring, while operating in the power state, a downlink control channel for at least one of a downlink configured grant and an uplink configured grant.

In some examples, the mapping includes an additional codepoint that is mapped to a physical downlink control channel skipping operation.

In some examples, the first control message indicates a set of timers corresponding to the set of power states, and the power state component 635 is capable of, configured to, or operable to support a means for transitioning from the power state to a second power state based on expiry of a timer associated with the power state.

In some examples, the set of timers are associated with SSSG switching.

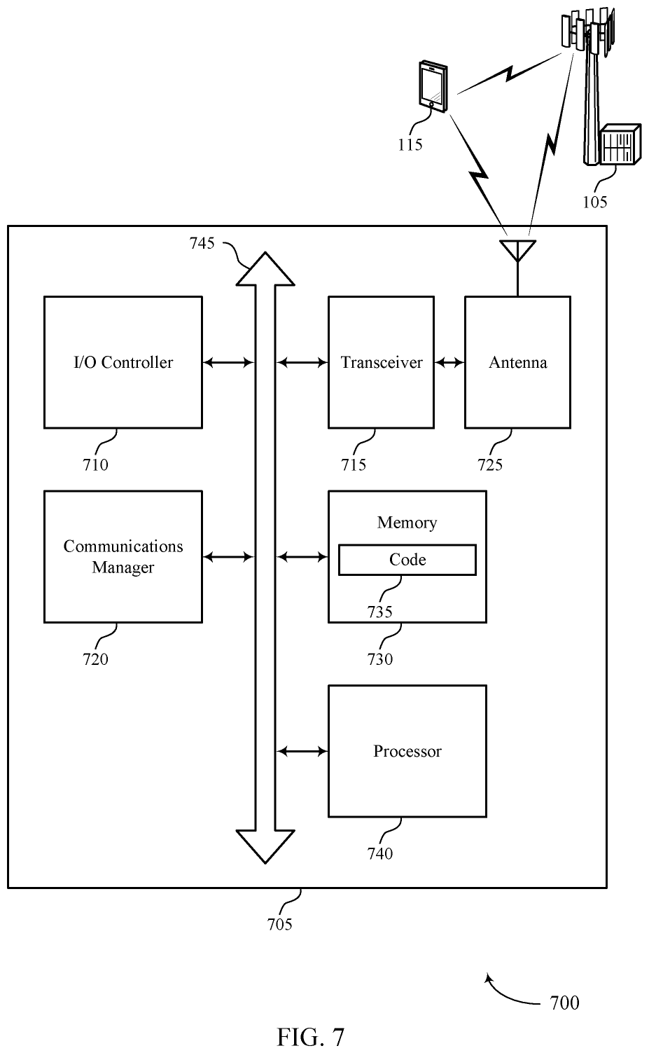

FIG. 7 shows a diagram of a system 700 including a device 705 that supports techniques for indicating communication power states in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for indicating communication power states). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 is capable of, configured to, or operable to support a means for receiving a first control message that indicates a mapping between individual ones of a set of power states and respective ones of a set of codepoints, each power state of the set of power states being for the UE or a network entity in communication with the UE and corresponding to a respective directional communication profile associated with the UE. The communications manager 720 is capable of, configured to, or operable to support a means for receiving a second control message that includes a codepoint from the set of codepoints, the codepoint corresponding to a power state from the set of power states in accordance with the mapping, inclusion of the codepoint in the second control message indicative of activation of the power state at the UE. The communications manager 720 is capable of, configured to, or operable to support a means for transitioning to the power state in accordance with the second control message.

By including or configuring the communications manager 720 in accordance with examples as described herein, the device 705 may support techniques for reduced latency, reduced power consumption, improved utilization of processing capabilities, and longer battery life. For example, the device 705 may reduce power consumption and improve battery life by transitioning between power states according to received codepoints as described herein. The device 705 may receive a first codepoint that activates a first power state at the device 705, where operation in the first power state includes turning off one or more modems of the device 705, which may reduce processing and power consumption. Additionally, the device 705 may receive a second codepoint that activates a second power state at the device 705. The second power state may be associated with relatively higher throughput at the device 705. The device 705 may transition to the second power state to reduce communications latency.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for indicating communication power states as described herein, or the processor 740 and the memory 730 may be otherwise configured to perform or support such operations.

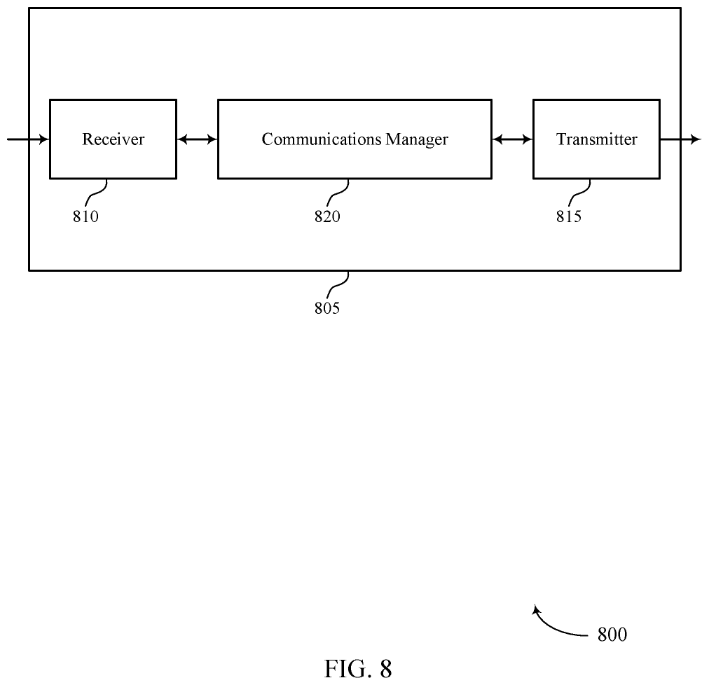

FIG. 8 shows a block diagram 800 of a device 805 that supports techniques for indicating communication power states in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of techniques for indicating communication power states as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software) executed by a processor. If implemented in code executed by a processor, the functions of the communications manager 820, the receiver 810, the transmitter 815, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 is capable of, configured to, or operable to support a means for transmitting, to a UE, a first control message that indicates a mapping between individual ones of a set of power states and respective ones of a set of codepoints, each power state of the set of power states being for the UE or the network entity and corresponding to a respective directional communication profile associated with the UE. The communications manager 820 is capable of, configured to, or operable to support a means for transmitting, to the UE, a second control message that includes a codepoint from the set of codepoints, the codepoint corresponding to a power state from the set of power states in accordance with the mapping, inclusion of the codepoint in the second control message indicative of activation of the power state. The communications manager 820 is capable of, configured to, or operable to support a means for operating in accordance with the power state at the UE.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing and more efficient utilization of communication resources. For example, by utilizing one or more codepoints to indicate and activate one or more power states at a device in communication with the device 805, the device 805 may quickly and efficiently transition between one of multiple power states. In a power state associated with relatively low power consumption, the processor of the device 805 may refrain from transmitting downlink signals or refrain from monitoring for uplink signals, which may reduce processing, reduce a capacity of an associated channel, and thereby improve utilization of communication resources.

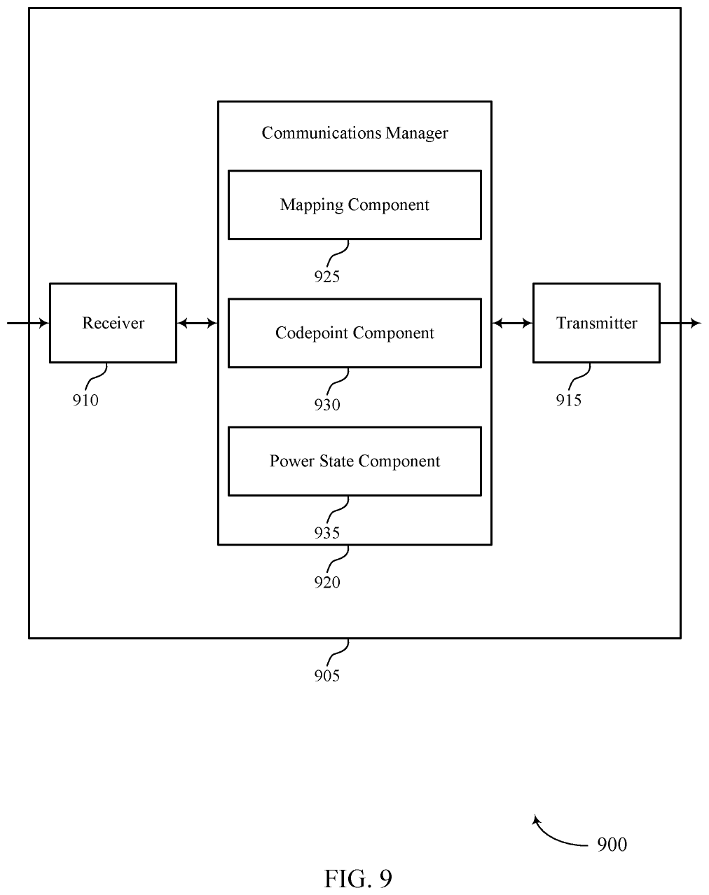

FIG. 9 shows a block diagram 900 of a device 905 that supports techniques for indicating communication power states in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for indicating communication power states as described herein. For example, the communications manager 920 may include a mapping component 925, a codepoint component 930, a power state component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The mapping component 925 is capable of, configured to, or operable to support a means for transmitting, to a UE, a first control message that indicates a mapping between individual ones of a set of power states and respective ones of a set of codepoints, each power state of the set of power states being for the UE or the network entity and corresponding to a respective directional communication profile associated with the UE. The codepoint component 930 is capable of, configured to, or operable to support a means for transmitting, to the UE, a second control message that includes a codepoint from the set of codepoints, the codepoint corresponding to a power state from the set of power states in accordance with the mapping, inclusion of the codepoint in the second control message indicative of activation of the power state. The power state component 935 is capable of, configured to, or operable to support a means for operating in accordance with the power state at the UE.

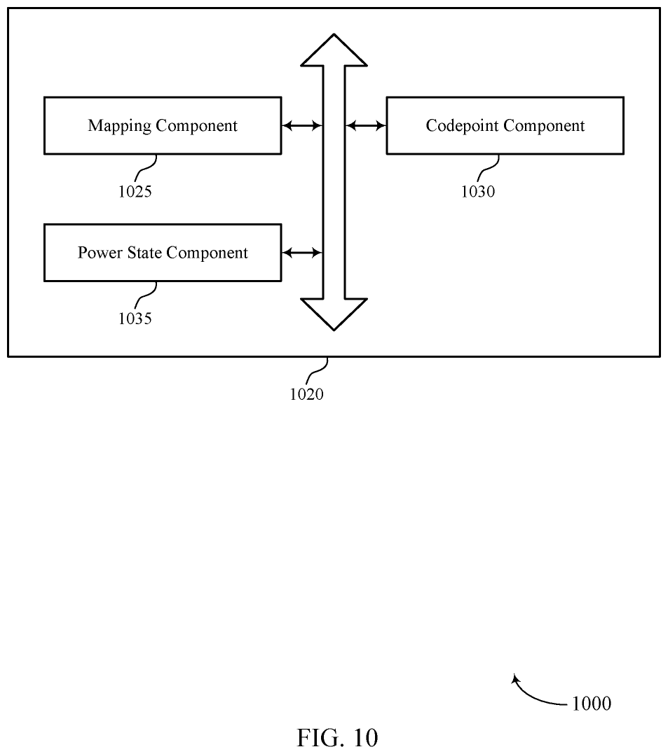

FIG. 10 shows a block diagram 1000 of a communications manager 1020 that supports techniques for indicating communication power states in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for indicating communication power states as described herein. For example, the communications manager 1020 may include a mapping component 1025, a codepoint component 1030, a power state component 1035, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The mapping component 1025 is capable of, configured to, or operable to support a means for transmitting, to a UE, a first control message that indicates a mapping between individual ones of a set of power states and respective ones of a set of codepoints, each power state of the set of power states being for the UE or the network entity and corresponding to a respective directional communication profile associated with the UE. The codepoint component 1030 is capable of, configured to, or operable to support a means for transmitting, to the UE, a second control message that includes a codepoint from the set of codepoints, the codepoint corresponding to a power state from the set of power states in accordance with the mapping, inclusion of the codepoint in the second control message indicative of activation of the power state. The power state component 1035 is capable of, configured to, or operable to support a means for operating in accordance with the power state at the UE.

In some examples, the second control message includes the codepoint within a field associated with a SSSG switching indication, and the method includes. In some examples, the codepoint component 1030 is capable of, configured to, or operable to support a means for transmitting an indication that the codepoint is associated with the power state instead of with a SSSG switching indication.

In some examples, the mapping component 1025 is capable of, configured to, or operable to support a means for transmitting an indication that changes an activation state of the mapping between the individual ones of the set of power states and the respective ones of the set of codepoints, where the activation state is one of an activated state or a deactivated state.

In some examples, the respective directional communication profile is associated with a BWP for a primary cell, one or more BWPs for one or more secondary cells, a dormant BWP for the primary cell, a dormant BWP for the one or more secondary cells, restricted reception of a data channel in the BWP for the primary cell, restricted reception of a control channel in the BWP for the primary cell, restricted reception of the data channel in the one or more BWPs for the one or more secondary cells, restricted reception of the control channel in the one or more BWPs for the one or more secondary cells, or a combination thereof.

In some examples, the set of power states includes a modem-off power state, one or more uplink-only power states corresponding to different uplink communication rates, one or more downlink-only power states corresponding to different downlink communication rates, an uplink-and-downlink power state, or combinations thereof.

In some examples, the power state includes a modem-off power state, and the power state component 1035 is capable of, configured to, or operable to support a means for pausing a monitoring of an uplink control channel and an uplink shared channel. In some examples, the power state includes a modem-off power state, and the power state component 1035 is capable of, configured to, or operable to support a means for pausing transmission of a downlink control channel and a downlink shared channel.

In some examples, the power state includes an uplink-only power state, and the power state component 1035 is capable of, configured to, or operable to support a means for pausing transmission of a downlink shared channel. In some examples, the power state includes an uplink-only power state, and the power state component 1035 is capable of, configured to, or operable to support a means for transmitting, via a downlink control channel, an uplink configured grant indicating one or more sets of periodic uplink resources. In some examples, the power state includes an uplink-only power state, and the power state component 1035 is capable of, configured to, or operable to support a means for receiving, from the UE via an uplink shared channel, an uplink message in accordance with the uplink configured grant.

In some examples, the power state includes a downlink-only power state, and the power state component 1035 is capable of, configured to, or operable to support a means for pausing a monitoring of at least one of an uplink control channel and an uplink shared channel. In some examples, the power state includes a downlink-only power state, and the power state component 1035 is capable of, configured to, or operable to support a means for transmitting, via a downlink control channel, a downlink configured grant indicating one or more downlink resources. In some examples, the power state includes a downlink-only power state, and the power state component 1035 is capable of, configured to, or operable to support a means for transmitting, via a downlink shared channel, a downlink message in accordance with the downlink configured grant.

In some examples, the power state includes an uplink-and-downlink power state, and the power state component 1035 is capable of, configured to, or operable to support a means for transmitting, via a downlink control channel, at least one of a downlink configured grant and an uplink configured grant.

In some examples, the mapping includes an additional codepoint that is mapped to a physical downlink control channel skipping operation.

In some examples, the first control message indicates a set of timers corresponding to the set of power states.

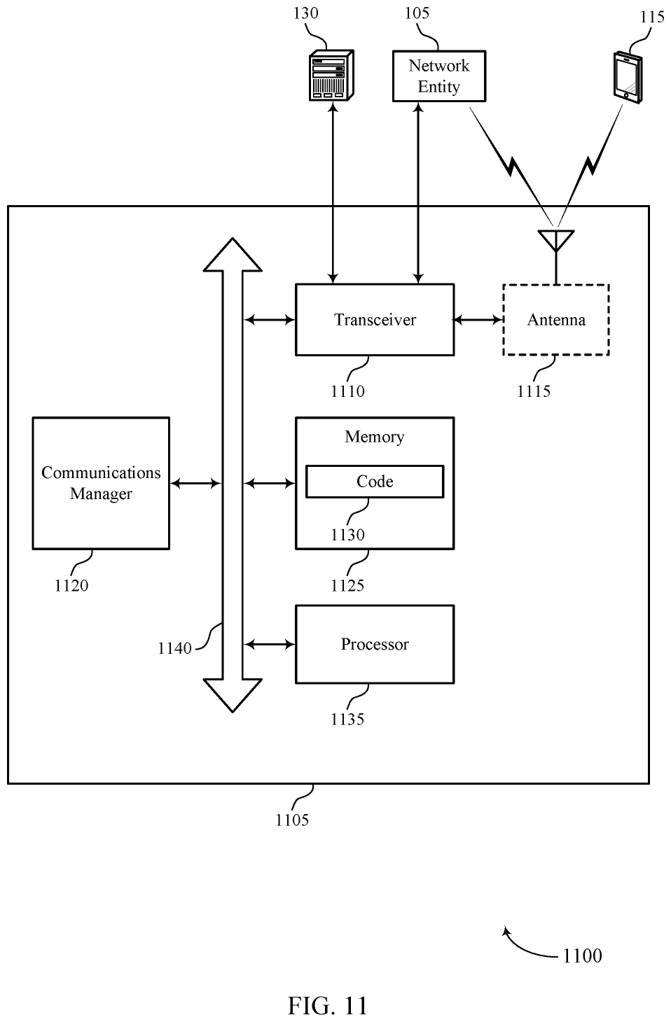

FIG. 11 shows a diagram of a system 1100 including a device 1105 that supports techniques for indicating communication power states in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting techniques for indicating communication power states). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 is capable of, configured to, or operable to support a means for transmitting, to a UE, a first control message that indicates a mapping between individual ones of a set of power states and respective ones of a set of codepoints, each power state of the set of power states being for the UE or the network entity and corresponding to a respective directional communication profile associated with the UE. The communications manager 1120 is capable of, configured to, or operable to support a means for transmitting, to the UE, a second control message that includes a codepoint from the set of codepoints, the codepoint corresponding to a power state from the set of power states in accordance with the mapping, inclusion of the codepoint in the second control message indicative of activation of the power state. The communications manager 1120 is capable of, configured to, or operable to support a means for operating in accordance with the power state at the UE.

By including or configuring the communications manager 1120 in accordance with examples as described herein, the device 1105 may support techniques for reduced processing and more efficient utilization of communication resources. For example, by utilizing one or more codepoints to indicate and activate one or more power states at a device in communication with the device 1105, the device 805 may quickly and efficiently transition between one of multiple power states, which may improve coordination between devices and reduce latency. In a power state associated with relatively low power consumption, the processor of the device 1105 may refrain from transmitting downlink signals or refrain from monitoring for uplink signals, which may reduce processing, reduce a capacity of an associated channel, and thereby improve utilization of communication resources.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of techniques for indicating communication power states as described herein, or the processor 1135 and the memory 1125 may be otherwise configured to perform or support such operations.

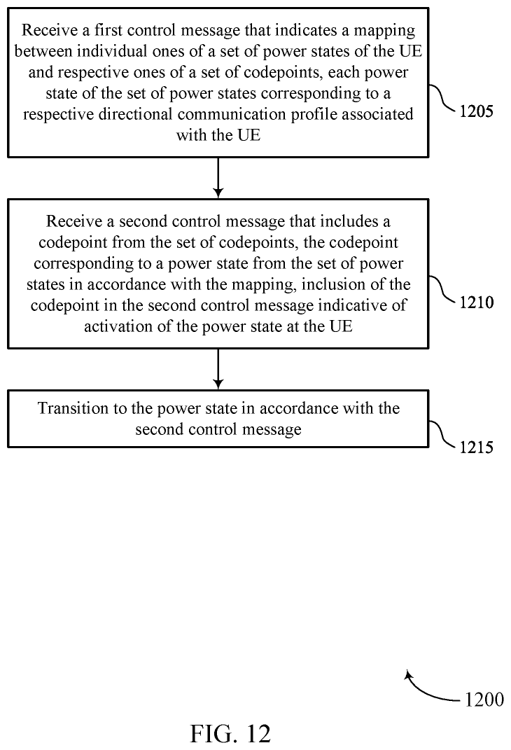

FIG. 12 shows a flowchart illustrating a method 1200 that supports techniques for indicating communication power states in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a first control message that indicates a mapping between individual ones of a set of power states and respective ones of a set of codepoints, each power state of the set of power states being for the UE or a network entity in communication with the UE and corresponding to a respective directional communication profile associated with the UE. The operations of block 1205 may be performed in accordance with examples as disclosed herein. In some examples, aspects of the operations of 1205 may be performed by a mapping component 625 as described with reference to FIG. 6.

At 1210, the method may include receiving a second control message that includes a codepoint from the set of codepoints, the codepoint corresponding to a power state from the set of power states in accordance with the mapping, inclusion of the codepoint in the second control message indicative of activation of the power state at the UE. The operations of block 1210 may be performed in accordance with examples as disclosed herein. In some examples, aspects of the operations of 1210 may be performed by a codepoint component 630 as described with reference to FIG. 6.

At 1215, the method may include transitioning to the power state in accordance with the second control message. The operations of block 1215 may be performed in accordance with examples as disclosed herein. In some examples, aspects of the operations of 1215 may be performed by a power state component 635 as described with reference to FIG. 6.

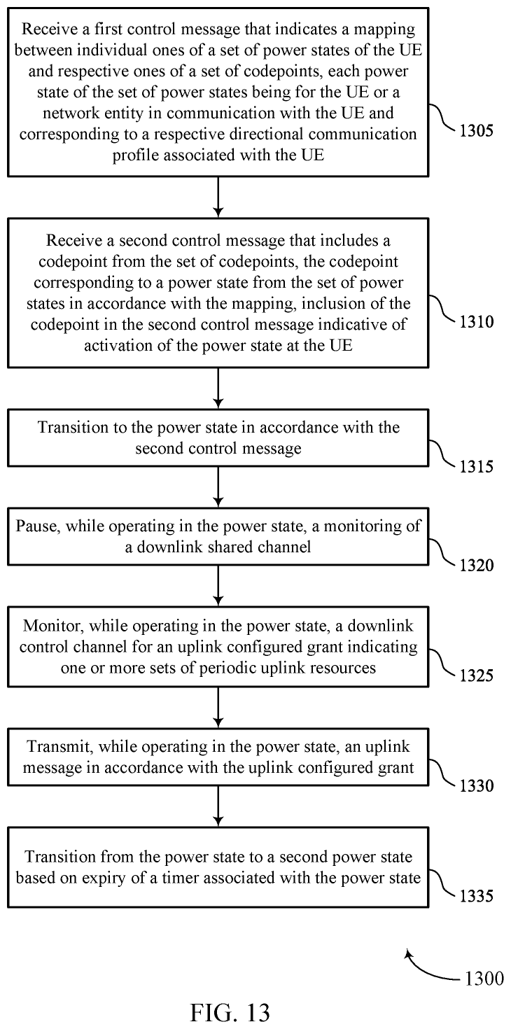

FIG. 13 shows a flowchart illustrating a method 1300 that supports techniques for indicating communication power states in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a first control message that indicates a mapping between individual ones of a set of power states and respective ones of a set of codepoints, each power state of the set of power states being for the UE or a network entity in communication with the UE and corresponding to a respective directional communication profile associated with the UE. The operations of block 1305 may be performed in accordance with examples as disclosed herein. In some examples, aspects of the operations of 1305 may be performed by a mapping component 625 as described with reference to FIG. 6.

At 1310, the method may include receiving a second control message that includes a codepoint from the set of codepoints, the codepoint corresponding to a power state from the set of power states in accordance with the mapping, inclusion of the codepoint in the second control message indicative of activation of the power state at the UE. The operations of block 1310 may be performed in accordance with examples as disclosed herein. In some examples, aspects of the operations of 1310 may be performed by a codepoint component 630 as described with reference to FIG. 6.

At 1315, the method may include transitioning to the power state in accordance with the second control message. The operations of block 1315 may be performed in accordance with examples as disclosed herein. In some examples, aspects of the operations of 1315 may be performed by a power state component 635 as described with reference to FIG. 6.

At 1320, the method may include pausing, while operating in the power state, a monitoring of a downlink shared channel. The operations of block 1320 may be performed in accordance with examples as disclosed herein. In some examples, aspects of the operations of 1320 may be performed by a power state component 635 as described with reference to FIG. 6.

At 1325, the method may include monitoring, while operating in the power state, a downlink control channel for an uplink configured grant indicating one or more sets of periodic uplink resources. The operations of block 1325 may be performed in accordance with examples as disclosed herein. In some examples, aspects of the operations of 1325 may be performed by a power state component 635 as described with reference to FIG. 6.

At 1330, the method may include transmitting, while operating in the power state, an uplink message in accordance with the uplink configured grant. The operations of block 1330 may be performed in accordance with examples as disclosed herein. In some examples, aspects of the operations of 1330 may be performed by a power state component 635 as described with reference to FIG. 6.

At 1335, the method may include transitioning from the power state to a second power state based on expiry of a timer associated with the power state. The operations of block 1335 may be performed in accordance with examples as disclosed herein. In some examples, aspects of the operations of 1335 may be performed by a power state component 635 as described with reference to FIG. 6.

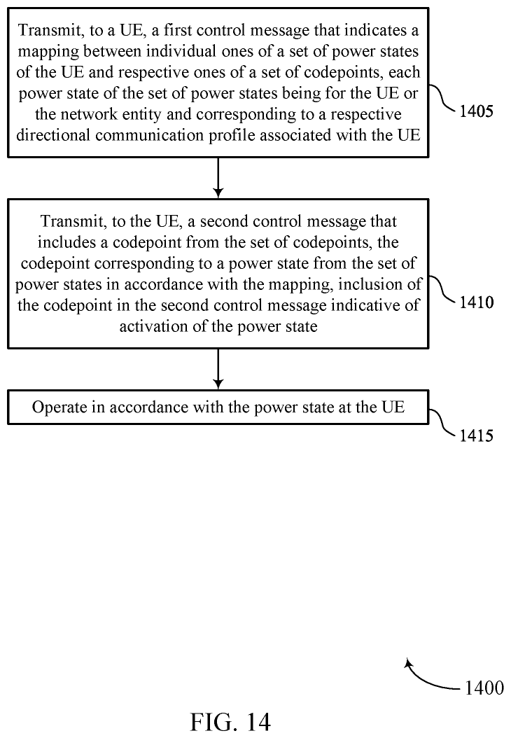

FIG. 14 shows a flowchart illustrating a method 1400 that supports techniques for indicating communication power states in accordance with aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, to a UE, a first control message that indicates a mapping between individual ones of a set of power states and respective ones of a set of codepoints, each power state of the set of power states being for the UE or the network entity and corresponding to a respective directional communication profile associated with the UE. The operations of block 1405 may be performed in accordance with examples as disclosed herein. In some examples, aspects of the operations of 1405 may be performed by a mapping component 1025 as described with reference to FIG. 10.

At 1410, the method may include transmitting, to the UE, a second control message that includes a codepoint from the set of codepoints, the codepoint corresponding to a power state from the set of power states in accordance with the mapping, inclusion of the codepoint in the second control message indicative of activation of the power state. The operations of block 1410 may be performed in accordance with examples as disclosed herein. In some examples, aspects of the operations of 1410 may be performed by a codepoint component 1030 as described with reference to FIG. 10.

At 1415, the method may include operating in accordance with the power state at the UE. The operations of block 1415 may be performed in accordance with examples as disclosed herein. In some examples, aspects of the operations of 1415 may be performed by a power state component 1035 as described with reference to FIG. 10.

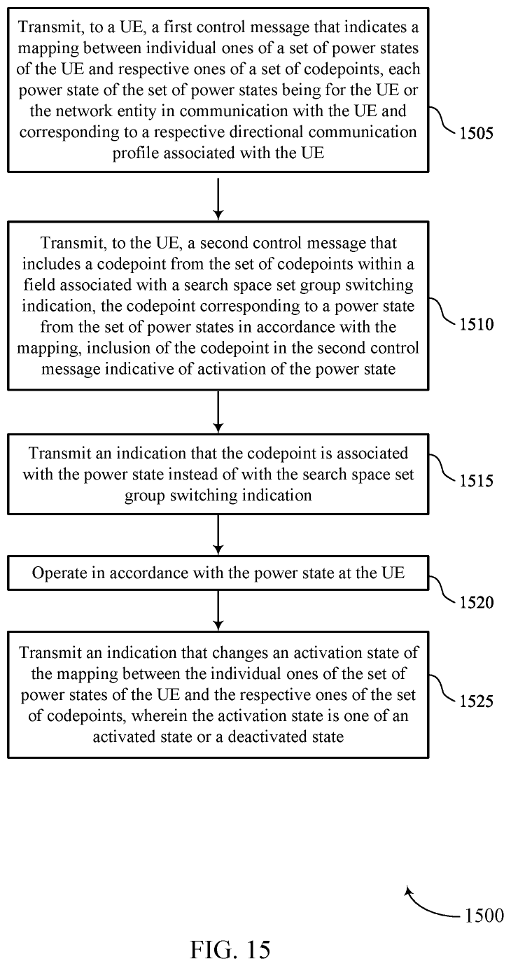

FIG. 15 shows a flowchart illustrating a method 1500 that supports techniques for indicating communication power states in accordance with aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, a first control message that indicates a mapping between individual ones of a set of power states and respective ones of a set of codepoints, each power state of the set of power states being for the UE or the network entity and corresponding to a respective directional communication profile associated with the UE. The operations of block 1505 may be performed in accordance with examples as disclosed herein. In some examples, aspects of the operations of 1505 may be performed by a mapping component 1025 as described with reference to FIG. 10.

At 1510, the method may include transmitting, to the UE, a second control message that includes a codepoint from the set of codepoints within a field associated with a search space set group switching indication, the codepoint corresponding to a power state from the set of power states in accordance with the mapping, inclusion of the codepoint in the second control message indicative of activation of the power state. The operations of block 1510 may be performed in accordance with examples as disclosed herein. In some examples, aspects of the operations of 1510 may be performed by a codepoint component 1030 as described with reference to FIG. 10.

At 1515, the method may include transmitting an indication that the codepoint is associated with the power state instead of with the search space set group switching indication. The operations of block 1515 may be performed in accordance with examples as disclosed herein. In some examples, aspects of the operations of 1515 may be performed by a codepoint component 1030 as described with reference to FIG. 10.

At 1520, the method may include operating in accordance with the power state at the UE. The operations of block 1520 may be performed in accordance with examples as disclosed herein. In some examples, aspects of the operations of 1520 may be performed by a power state component 1035 as described with reference to FIG. 10.

At 1525, the method may include transmitting an indication that changes an activation state of the mapping between the individual ones of the set of power states and the respective ones of the set of codepoints, where the activation state is one of an activated state or a deactivated state. The operations of block 1525 may be performed in accordance with examples as disclosed herein. In some examples, aspects of the operations of 1525 may be performed by a mapping component 1025 as described with reference to FIG. 10.

The following provides an overview of aspects of the present disclosure:
Aspect 1: A method for wireless communications at a UE, comprising: receiving a first control message that indicates a mapping between individual ones of a set of power states and respective ones of a set of codepoints, each power state of the set of power states being for the UE or a network entity in communication with the UE and corresponding to a respective directional communication profile associated with the UE; receiving a second control message that includes a codepoint from the set of codepoints, the codepoint corresponding to a power state from the set of power states in accordance with the mapping, inclusion of the codepoint in the second control message indicative of activation of the power state at the UE; and transitioning to the power state in accordance with the second control message.
Aspect 2: The method of aspect 1, wherein the second control message includes the codepoint within a field associated with an SSSG switching indication, wherein the method comprises: receiving an indication that the codepoint is associated with the power state instead of with an SSSG switching indication.
Aspect 3: The method of any of aspects 1 through 2, wherein the method comprises: receiving an indication that changes an activation state of the mapping between the individual ones of the set of power states and the respective ones of the set of codepoints, wherein the activation state is one of an activated state or a deactivated state.
Aspect 4: The method of any of aspects 1 through 3, wherein the respective directional communication profile is associated with one or more of a BWP for a primary cell, one or more BWPs for one or more secondary cells, a dormant BWP for the primary cell, a dormant BWP for the one or more secondary cells, restricted reception of a data channel in the BWP for the primary cell, restricted reception of a control channel in the BWP for the primary cell, restricted reception of the data channel in the one or more BWPs for the one or more secondary cells, restricted reception of the control channel in the one or more BWPs for the one or more secondary cells, or a combination thereof.
Aspect 5: The method of any of aspects 1 through 4, wherein the set of power states comprises a modem-off power state, one or more uplink-only power states corresponding to different uplink communication rates, one or more downlink-only power states corresponding to different downlink communication rates, an uplink-and-downlink power state, or combinations thereof.
Aspect 6: The method of any of aspects 1 through 5, wherein the power state comprises a modem-off power state, the method further comprising: pausing, while operating in the power state, a monitoring of a downlink control channel and a downlink shared channel; and pausing, while operating in the power state, transmission of an uplink control channel and an uplink shared channel.
Aspect 7: The method of any of aspects 1 through 6, wherein the power state comprises an uplink-only power state, the method further comprising: pausing, while operating in the power state, a monitoring of a downlink shared channel; monitoring, while operating in the power state, a downlink control channel for an uplink configured grant indicating one or more sets of periodic uplink resources; and transmitting, while operating in the power state, an uplink message in accordance with the uplink configured grant.
Aspect 8: The method of any of aspects 1 through 7, wherein the power state comprises a downlink-only power state, the method further comprising: pausing, while operating in the power state, transmission of at least one of an uplink control channel and an uplink shared channel; monitoring, while operating in the power state, a downlink control channel for a downlink configured grant indicating one or more downlink resources; and monitoring, while operating in the power state, a downlink shared channel for a downlink message in accordance with the downlink configured grant.
Aspect 9: The method of any of aspects 1 through 8, wherein the power state comprises an uplink-and-downlink power state, the method further comprising: monitoring, while operating in the power state, a downlink control channel for at least one of a downlink configured grant and an uplink configured grant.
Aspect 10: The method of any of aspects 1 through 9, wherein the mapping includes an additional codepoint that is mapped to a physical downlink control channel skipping operation.
Aspect 11: The method of any of aspects 1 through 10, wherein the first control message indicates a set of timers corresponding to the set of power states, the method further comprising: transitioning from the power state to a second power state based at least in part on expiry of a timer associated with the power state.
Aspect 12: The method of aspect 11, wherein the set of timers are associated with SSSG switching.
Aspect 13: A method for wireless communications at a network entity, comprising: transmitting, to a UE, a first control message that indicates a mapping between individual ones of a set of power states and respective ones of a set of codepoints, each power state of the set of power states being for the UE or the network entity and corresponding to a respective directional communication profile associated with the UE; transmitting, to the UE, a second control message that includes a codepoint from the set of codepoints, the codepoint corresponding to a power state from the set of power states in accordance with the mapping, inclusion of the codepoint in the second control message indicative of activation of the power state; and operating in accordance with the power state at the UE.
Aspect 14: The method of aspect 13, wherein the second control message includes the codepoint within a field associated with an SSSG switching indication, wherein the method comprises: transmitting an indication that the codepoint is associated with the power state instead of with an SSSG switching indication.
Aspect 15: The method of any of aspects 13 through 14, further comprising: transmitting an indication that changes an activation state of the mapping between the individual ones of the set of power states and the respective ones of the set of codepoints, wherein the activation state is one of an activated state or a deactivated state.
Aspect 16: The method of any of aspects 13 through 15, wherein the respective directional communication profile is associated with a BWP for a primary cell, one or more BWPs for one or more secondary cells, a dormant BWP for the primary cell, a dormant BWP for the one or more secondary cells, restricted reception of a data channel in the BWP for the primary cell, restricted reception of a control channel in the BWP for the primary cell, restricted reception of the data channel in the one or more BWPs for the one or more secondary cells, restricted reception of the control channel in the one or more BWPs for the one or more secondary cells, or a combination thereof.
Aspect 17: The method of any of aspects 13 through 16, wherein the set of power states comprises a modem-off power state, one or more uplink-only power states corresponding to different uplink communication rates, one or more downlink-only power states corresponding to different downlink communication rates, an uplink-and-downlink power state, or combinations thereof.
Aspect 18: The method of any of aspects 13 through 17, wherein the power state comprises a modem-off power state, the method further comprising: pausing a monitoring of an uplink control channel and an uplink shared channel; and pausing transmission of a downlink control channel and a downlink shared channel.
Aspect 19: The method of any of aspects 13 through 18, wherein the power state comprises an uplink-only power state, the method further comprising: pausing transmission of a downlink shared channel; transmitting, via a downlink control channel, an uplink configured grant indicating one or more sets of periodic uplink resources; and receiving, from the UE via an uplink shared channel, an uplink message in accordance with the uplink configured grant.
Aspect 20: The method of any of aspects 13 through 19, wherein the power state comprises a downlink-only power state, the method further comprising: pausing a monitoring of at least one of an uplink control channel and an uplink shared channel; transmitting, via a downlink control channel, a downlink configured grant indicating one or more downlink resources; and transmitting, via a downlink shared channel, a downlink message in accordance with the downlink configured grant.
Aspect 21: The method of any of aspects 13 through 20, wherein the power state comprises an uplink-and-downlink power state, the method further comprising: transmitting, via a downlink control channel, at least one of a downlink configured grant and an uplink configured grant.
Aspect 22: The method of any of aspects 13 through 21, wherein the mapping includes an additional codepoint that is mapped to a PDCCH skipping operation.
Aspect 23: The method of any of aspects 13 through 22, wherein the first control message indicates a set of timers corresponding to the set of power states.
Aspect 24: An apparatus for wireless communications at a UE, comprising at least one processor and memory coupled with the at least one processor, the memory storing instructions executable by the at least one processor to cause the apparatus to perform a method of any of aspects 1 through 12.
Aspect 25: An apparatus for wireless communications at a UE, comprising at least one means for performing a method of any of aspects 1 through 12.
Aspect 26: A non-transitory computer-readable medium storing code for wireless communications at a UE, the code comprising instructions executable by at least one processor to perform a method of any of aspects 1 through 12.
Aspect 27: An apparatus for wireless communications at a network entity, comprising at least one processor and memory coupled with the at least one processor, the memory storing instructions executable by the at least one processor to cause the apparatus to perform a method of any of aspects 13 through 23.
Aspect 28: An apparatus for wireless communications at a network entity, comprising at least one means for performing a method of any of aspects 13 through 23.
Aspect 29: A non-transitory computer-readable medium storing code for wireless communications at a network entity, the code comprising instructions executable by at least one processor to perform a method of any of aspects 13 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
memory coupled with the at least one processor, the memory storing instructions executable by the at least one processor to cause the UE to:
receive a first control message that indicates a mapping between individual ones of a set of power states and respective ones of a set of codepoints, each power state of the set of power states being for the UE or a network entity in communication with the UE and corresponding to a respective directional communication profile associated with the UE;
receive a second control message that includes a codepoint from the set of codepoints, the codepoint corresponding to a power state from the set of power states in accordance with the mapping, inclusion of the codepoint in the second control message indicative of activation of the power state at the UE; and
transition to the power state in accordance with the second control message.

2. The apparatus of claim 1, wherein:
the second control message includes the codepoint within a field associated with a search space set group switching indication, wherein the instructions are further executable by the at least one processor to cause the UE to:
receive an indication that the codepoint is associated with the power state instead of with a search space set group switching indication.

3. The apparatus of claim 1, wherein the instructions are further executable by the at least one processor to cause the UE to:
receive an indication that changes an activation state of the mapping between the individual ones of the set of power states and the respective ones of the set of codepoints, wherein the activation state is one of an activated state or a deactivated state.

4. The apparatus of claim 1, wherein the respective directional communication profile is associated with one or more of a BWP for a primary cell, one or more BWPs for one or more secondary cells, a dormant BWP for the primary cell, a dormant BWP for the one or more secondary cells, restricted reception of a data channel in the BWP for the primary cell, restricted reception of a control channel in the BWP for the primary cell, restricted reception of the data channel in the one or more BWPs for the one or more secondary cells, restricted reception of the control channel in the one or more BWPs for the one or more secondary cells, or a combination thereof.

5. The apparatus of claim 1, wherein the set of power states comprises a modem-off power state, one or more uplink-only power states corresponding to different uplink communication rates, one or more downlink-only power states corresponding to different downlink communication rates, an uplink-and-downlink power state, or combinations thereof.

6. The apparatus of claim 1, wherein the power state comprises a modem-off power state, and the instructions are further executable by the at least one processor to cause the UE to:
pause, while operating in the power state, a monitoring of a downlink control channel and a downlink shared channel; and
pause, while operating in the power state, transmission of an uplink control channel and an uplink shared channel.

7. The apparatus of claim 1, wherein the power state comprises an uplink-only power state, and the instructions are further executable by the at least one processor to cause the UE to:
pause, while operating in the power state, a monitoring of a downlink shared channel;
monitor, while operating in the power state, a downlink control channel for an uplink configured grant indicating one or more sets of periodic uplink resources; and
transmit, while operating in the power state, an uplink message in accordance with the uplink configured grant.

8. The apparatus of claim 1, wherein the power state comprises a downlink-only power state, and the instructions are further executable by the at least one processor to cause the UE to:
pause, while operating in the power state, transmission of at least one of an uplink control channel and an uplink shared channel;
monitor, while operating in the power state, a downlink control channel for a downlink configured grant indicating one or more downlink resources; and
monitor, while operating in the power state, a downlink shared channel for a downlink message in accordance with the downlink configured grant.

9. The apparatus of claim 1, wherein the power state comprises an uplink-and-downlink power state, and the instructions are further executable by the at least one processor to cause the UE to:
monitor, while operating in the power state, a downlink control channel for at least one of a downlink configured grant and an uplink configured grant.

10. The apparatus of claim 1, wherein the mapping includes an additional codepoint that is mapped to a physical downlink control channel skipping operation.

11. The apparatus of claim 1, wherein the first control message indicates a set of timers corresponding to the set of power states, and the instructions are further executable by the at least one processor to cause the UE to:
transition from the power state to a second power state based at least in part on expiry of a timer associated with the power state.

12. The apparatus of claim 11, wherein the set of timers are associated with search space set group switching.

13. An apparatus for wireless communications at a network entity, comprising:
at least one processor; and
memory coupled with the at least one processor, the memory storing instructions executable by the at least one processor to cause the network entity to:
transmit, to a user equipment (UE), a first control message that indicates a mapping between individual ones of a set of power states and respective ones of a set of codepoints, each power state of the set of power states being for the UE or the network entity and corresponding to a respective directional communication profile associated with the UE;
transmit, to the UE, a second control message that includes a codepoint from the set of codepoints, the codepoint corresponding to a power state from the set of power states in accordance with the mapping, inclusion of the codepoint in the second control message indicative of activation of the power state; and
operate in accordance with the power state at the UE.

14. The apparatus of claim 13, wherein:
the second control message includes the codepoint within a field associated with a search space set group switching indication, wherein the instructions are executable by the at least one processor to cause the network entity to:
transmit an indication that the codepoint is associated with the power state instead of with a search space set group switching indication.

15. The apparatus of claim 13, wherein the instructions are executable by the at least one processor to cause the network entity to:
transmit an indication that changes an activation state of the mapping between the individual ones of the set of power states and the respective ones of the set of codepoints, wherein the activation state is one of an activated state or a deactivated state.

16. The apparatus of claim 13, wherein the respective directional communication profile is associated with a BWP for a primary cell, one or more BWPs for one or more secondary cells, a dormant BWP for the primary cell, a dormant BWP for the one or more secondary cells, restricted reception of a data channel in the BWP for the primary cell, restricted reception of a control channel in the BWP for the primary cell, restricted reception of the data channel in the one or more BWPs for the one or more secondary cells, restricted reception of the control channel in the one or more BWPs for the one or more secondary cells, or a combination thereof.

17. The apparatus of claim 13, wherein the set of power states comprises a modem-off power state, one or more uplink-only power states corresponding to different uplink communication rates, one or more downlink-only power states corresponding to different downlink communication rates, an uplink-and-downlink power state, or combinations thereof.

18. The apparatus of claim 13, wherein the power state comprises a modem-off power state, and the instructions are further executable by the at least one processor to cause the network entity to:
pause a monitoring of an uplink control channel and an uplink shared channel; and
pause transmission of a downlink control channel and a downlink shared channel.

19. The apparatus of claim 13, wherein the power state comprises an uplink-only power state, and the instructions are further executable by the at least one processor to cause the network entity to:
pause transmission of a downlink shared channel;
transmit, via a downlink control channel, an uplink configured grant indicating one or more sets of periodic uplink resources; and
receive, from the UE via an uplink shared channel, an uplink message in accordance with the uplink configured grant.

20. The apparatus of claim 13, wherein the power state comprises a downlink-only power state, and the instructions are further executable by the at least one processor to cause the network entity to:
pause a monitoring of at least one of an uplink control channel and an uplink shared channel;
transmit, via a downlink control channel, a downlink configured grant indicating one or more downlink resources; and
transmit, via a downlink shared channel, a downlink message in accordance with the downlink configured grant.

21. The apparatus of claim 13, wherein the power state comprises an uplink-and-downlink power state, and the instructions are further executable by the at least one processor to cause the network entity to:
transmit, via a downlink control channel, at least one of a downlink configured grant and an uplink configured grant.

22. The apparatus of claim 13, wherein the mapping includes an additional codepoint that is mapped to a physical downlink control channel skipping operation.

23. The apparatus of claim 13, wherein the first control message indicates a set of timers corresponding to the set of power states.

24. A method for wireless communications at a user equipment (UE), comprising:
receiving a first control message that indicates a mapping between individual ones of a set of power states and respective ones of a set of codepoints, each power state of the set of power states being for the UE or a network entity in communication with the UE and corresponding to a respective directional communication profile associated with the UE;
receiving a second control message that includes a codepoint from the set of codepoints, the codepoint corresponding to a power state from the set of power states in accordance with the mapping, inclusion of the codepoint in the second control message indicative of activation of the power state at the UE; and
transitioning to the power state in accordance with the second control message.

25. The method of claim 24, wherein:
the second control message includes the codepoint within a field associated with a search space set group switching indication, wherein the method comprises:
receiving an indication that the codepoint is associated with the power state instead of with a search space set group switching indication.

26. The method of claim 24, wherein the method comprises:
receiving an indication that changes an activation state of the mapping between the individual ones of the set of power states and the respective ones of the set of codepoints, wherein the activation state is one of an activated state or a deactivated state.

27. The method of claim 24, wherein the respective directional communication profile is associated with one or more of a BWP for a primary cell, one or more BWPs for one or more secondary cells, a dormant BWP for the primary cell, a dormant BWP for the one or more secondary cells, restricted reception of a data channel in the BWP for the primary cell, restricted reception of a control channel in the BWP for the primary cell, restricted reception of the data channel in the one or more BWPs for the one or more secondary cells, restricted reception of the control channel in the one or more BWPs for the one or more secondary cells, or a combination thereof.

28. A method for wireless communications at a network entity, comprising:
transmitting, to a user equipment (UE), a first control message that indicates a mapping between individual ones of a set of power states and respective ones of a set of codepoints, each power state of the set of power states being for the UE or the network entity and corresponding to a respective directional communication profile associated with the UE;
transmitting, to the UE, a second control message that includes a codepoint from the set of codepoints, the codepoint corresponding to a power state from the set of power states in accordance with the mapping, inclusion of the codepoint in the second control message indicative of activation of the power state; and
operating in accordance with the power state at the UE.

29. The method of claim 28, wherein:
the second control message includes the codepoint within a field associated with a search space set group switching indication, wherein the method comprises:
transmitting an indication that the codepoint is associated with the power state instead of with a search space set group switching indication.

30. The method of claim 28, wherein the method comprises:
transmitting an indication that changes an activation state of the mapping between the individual ones of the set of power states and the respective ones of the set of codepoints, wherein the activation state is one of an activated state or a deactivated state.
